(19) United States
(12) Patent Application Publication
(10) Pub. No.: US 2025/0259424 A1
(43) Pub. Date: Aug. 14, 2025

(54) METHOD AND APPARATUS FOR GENERATING SAMPLE PALM PRINT IMAGE, DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Lei SHEN, Shenzhen (CN); Ruixin ZHANG, Shenzhen (CN); Shouhong DING, Shenzhen (CN)

(21) Appl. No.: 19/193,298

(22) Filed: Apr. 29, 2025

Related U.S. Application Data
(63) Continuation of application No. PCT/CN2024/080278, filed on Mar. 6, 2024.

(30) Foreign Application Priority Data
Apr. 19, 2023 (CN) 202310464871.8

(51) Int. Cl. G06V 10/774; G06V 10/44; G06V 10/74; G06V 10/77; G06V 40/12

(52) U.S. Cl. CPC G06V 10/774; G06V 10/44; G06V 10/761; G06V 10/7715; G06V 40/1347; G06V 40/1365

(57) ABSTRACT

A sample palm print image generation method includes generating a major palm print line according to a preset major palm print line distribution pattern, determining a palm print distribution region in which the major palm print line is located, generating a minor palm print line in the palm print distribution region based on a preset minor palm print line distribution pattern, generating a candidate palm print image based at least on the major palm print line and the minor palm print line, labeling the candidate palm print image with a candidate image label that represents a palm print distribution of the candidate palm print image including at least one of a major palm print line distribution or a minor palm print line distribution, and inputting the candidate palm print image to a palm print generation model to obtain a sample palm print image.

### CROSS-REFERENCE TO RELATED APPLICATIONS

This application is a continuation of International Application No. PCT/CN2024/080278, filed on Mar. 6, 2024, which claims priority to Chinese Patent Application No. 2023104648718, entitled “METHOD AND APPARATUS FOR GENERATING PALM PRINT SAMPLE, DEVICE, MEDIUM, AND PROGRAM PRODUCT” and filed on Apr. 19, 2023, the entire contents of both of which are incorporated herein by reference.

### FIELD OF THE TECHNOLOGY

Embodiments of this application relate to the field of machine learning, and in particular, to a method and apparatus for generating a sample palm print image, a device, a medium, and a program product.

### BACKGROUND OF THE DISCLOSURE

With rapid development of information technologies, palm print recognition technology, due to its reliability and convenience, is increasingly widely applied to various identity authentication scenes. Compared with facial recognition, palm print recognition is a non-intrusive recognition method that performs identity recognition according to features such as major lines, texture, and wrinkles in a palm, and is more easily accepted by users.

In the related art, in palm print recognition, inherent patterns of palm print information in a gathered palm print image is usually learned by using a machine learning method, to enable a model to learn a potential feature having a more distinguishing power, and the palm print is recognized by using a trained model, to implement an identity recognition process.

However, due to the strong privacy of palm print images, the field of palm print recognition lacks a large public dataset for the model to learn. Moreover, authenticity of a randomly generated palm print sample is poor, which is not favorable for the model to learn good identity information, resulting in poor identity recognition effect of the model.

### SUMMARY

In accordance with the disclosure, there is provided a sample palm print image generation method including generating a major palm print line according to a preset major palm print line distribution pattern, determining a palm print distribution region in which the major palm print line is located, generating a minor palm print line in the palm print distribution region based on a preset minor palm print line distribution pattern, generating a candidate palm print image based at least on the major palm print line and the minor palm print line, labeling the candidate palm print image with a candidate image label that represents a palm print distribution of the candidate palm print image including at least one of a major palm print line distribution or a minor palm print line distribution, and inputting the candidate palm print image to a palm print generation model to obtain a sample palm print image. The palm print generation model is obtained through pre-training using at least the candidate image label and a palm print image label indicating a palm print distribution of a pre-gathered palm print image.

Also in accordance with the disclosure, there is provided a computer device including a processor, and a memory storing at least one program that, when executed by the processor, causes the processor to generate a major palm print line according to a preset major palm print line distribution pattern, determine a palm print distribution region in which the major palm print line is located, generate a minor palm print line in the palm print distribution region based on a preset minor palm print line distribution pattern, generate a candidate palm print image based at least on the major palm print line and the minor palm print line, label the candidate palm print image with a candidate image label that represents a palm print distribution of the candidate palm print image including at least one of a major palm print line distribution or a minor palm print line distribution, and input the candidate palm print image to a palm print generation model to obtain a sample palm print image. The palm print generation model is obtained through pre-training using at least the candidate image label and a palm print image label indicating a palm print distribution of a pre-gathered palm print image.

Also in accordance with the disclosure, there is provided a non-transitory computer-readable storage medium storing at least one program stored that, when executed by a processor, causes the processor to generate a major palm print line according to a preset major palm print line distribution pattern, determine a palm print distribution region in which the major palm print line is located, generate a minor palm print line in the palm print distribution region based on a preset minor palm print line distribution pattern, generate a candidate palm print image based at least on the major palm print line and the minor palm print line, label the candidate palm print image with a candidate image label that represents a palm print distribution of the candidate palm print image including at least one of a major palm print line distribution or a minor palm print line distribution, and input the candidate palm print image to a palm print generation model to obtain a sample palm print image. The palm print generation model is obtained through pre-training using at least the candidate image label and a palm print image label indicating a palm print distribution of a pre-gathered palm print image.

### BRIEF DESCRIPTION OF THE DRAWINGS

To describe the technical solutions of the embodiments of this application more clearly, the following briefly introduces the accompanying drawings needed for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram showing an implementation environment according to an exemplary embodiment of this application.

FIG. 2 is a flowchart of a method for generating a sample palm print image according to an exemplary embodiment of this application.

FIG. 3 is a schematic diagram showing a palm print of a palm according to an exemplary embodiment of this application.

FIG. 4 is a schematic diagram showing a candidate palm print image according to an exemplary embodiment of this application.

FIG. 5 is a flowchart of obtaining a palm print generation model through training according to an exemplary embodiment of this application.

FIG. 6 is a flowchart of a method for generating a sample palm print image according to another exemplary embodiment of this application.

FIG. 7 is a schematic diagram showing a Bezier curve according to an exemplary embodiment of this application.

FIG. 8 is a flowchart of a method for generating a sample palm print image according to still another exemplary embodiment of this application.

FIG. 9 is a flowchart of a method for generating a sample palm print image according to yet another exemplary embodiment of this application.

FIG. 10 is a flowchart of applying a target palm print recognition model according to an exemplary embodiment of this application.

FIG. 11 is an overall flowchart of a method for generating a sample palm print image according to an exemplary embodiment of this application.

FIG. 12 is a schematic diagram showing a third region according to an exemplary embodiment of this application.

FIG. 13 is a schematic diagram showing determination of a third region according to an exemplary embodiment of this application.

FIG. 14 is a schematic diagram showing a candidate palm print image according to an exemplary embodiment of this application.

FIG. 15 is a principle diagram showing a model in a training stage of a generative adversarial network according to an exemplary embodiment of this application.

FIG. 16 is a schematic diagram showing a network structure of a generator according to an exemplary embodiment of this application.

FIG. 17 is a schematic diagram showing training to obtain a target palm print recognition model according to an exemplary embodiment of this application.

FIG. 18 is a structural block diagram of an apparatus for generating a sample palm print image according to an exemplary embodiment of this application.

FIG. 19 is a structural block diagram of an apparatus for generating a sample palm print image according to another exemplary embodiment of this application.

FIG. 20 is a structural block diagram of a server according to an exemplary embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts fall within the protection scope of this application.

In the related art, in palm print recognition, inherent patterns of palm print information in a gathered palm print image is usually learned by using a machine learning method, to enable a model to learn a potential feature having a more distinguishing power, and the palm print is recognized by using a trained model, to implement an identity recognition process. However, due to the strong privacy of palm print images, the field of palm print recognition lacks a large public dataset for the model to learn. Moreover, authenticity of a randomly generated palm print sample is poor, which is not favorable for the model to learn good identity information, resulting in poor identity recognition effect of the model.

In an embodiment of this application, a method for generating a sample palm print image is provided, so that after a large quantity of and diverse candidate palm print images are obtained, constraint adjustment can be performed on the generated candidate palm print images by using a pre-gathered palm print image, thereby improving authenticity of the generated sample palm print image, and further facilitating improving robustness of a palm print recognition model. During application, the method for generating a sample palm print image obtained through training in this application includes a plurality of scenes such as a palm print recognition model training scene, a palm print encryption scene, and a palm print recognition scene. The foregoing application scenes are merely illustrative examples. The method for generating a sample palm print image according to this embodiment may alternatively be applied to other scenes. This is not limited in this embodiment of this application.

In this application, before related data of a user is collected and in the process of collecting the related data of the user, a prompt interface, a pop-up window, or voice prompt information may be displayed. The prompt interface, the pop-up window, or the voice prompt information is configured for prompting that the user is currently collecting the related data of the user, so that in this application, only after a confirmation operation transmitted by the user to the prompt interface or the pop-up window is obtained, the related operation of obtaining the related data of the user starts to be performed. Otherwise (namely, when no confirmation operation transmitted by the user to the prompt interface or the pop-up window is obtained), the related operation of obtaining the related data of the user ends. To be specific, the related data of the user is not obtained. In other words, all user data gathered in this application is gathered when the user agrees and authorizes, and the related user data needs to be collected, used, and processed by complying with related laws and regulations and standards of related countries and regions.

Secondly, an implementation environment involved in this embodiment of this application will be described. The method for generating a sample palm print image according to this embodiment of this application may be independently performed by a terminal, or may be performed by a server, or may be implemented by the terminal and the server through data interaction. This is not limited in this embodiment of this application. In some embodiments, an example in which the terminal and the server interact to perform a data transmission method is used for description.

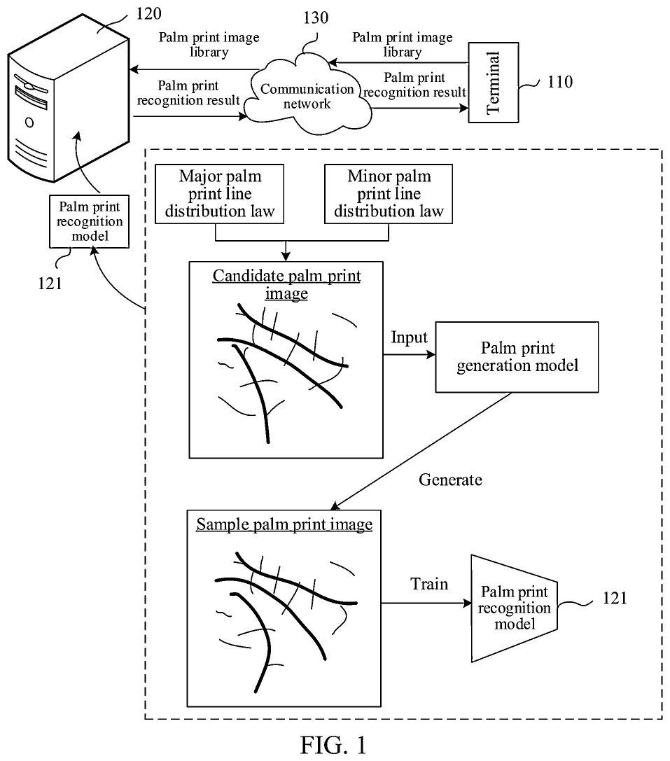

Schematically, referring to FIG. 1, the implementation environment involves a terminal 110 and a server 120. The terminal 110 is connected to the server 120 by using a communication network 130.

In some embodiments, an application having a palm print image obtaining function is installed in the terminal 110. Schematically, the terminal 110 is configured to transmit a palm print image library to the server 120. The palm print image library pre-stores a plurality of gathered palm print images. The server 120 may determine palm print data information such as a major palm print line distribution pattern and a major palm print line minor line distribution pattern according to the palm print image library.

Alternatively, an application having a palm print image analysis function is installed in the terminal 110. Schematically, the terminal 110 gathers a plurality of palm print images, and determines palm print data information such as a major palm print line distribution pattern and a major palm print line minor line distribution pattern after performing image analysis on the plurality of palm print images. Then, the terminal 110 transmits the major palm print line distribution pattern and the major palm print line minor line distribution pattern to the server 120.

In some embodiments, the server 120 generates at least one major palm print line according to a preset major palm print line distribution pattern, determines a palm print distribution region in which the at least one major palm print line is located, generates at least one minor palm print line in the palm print distribution region based on a preset minor palm print line distribution pattern, and forms a candidate palm print image by using the at least one major palm print line and the at least one minor palm print line. The candidate palm print image is labeled with a candidate image label, and the candidate image label is configured for representing distribution of the major palm print line in the candidate palm print image.

In some embodiments, the server 120 inputs the candidate palm print image to a palm print generation model obtained through pre-training, to obtain a sample palm print image. The palm print generation model is a model obtained through pre-training by using a palm print image label of a pre-gathered palm print image and the candidate image label, and the palm print image label is configured for indicating a palm print distribution of the palm print image.

In some embodiments, the sample palm print image obtained by processing the candidate palm print image through the palm print generation model is configured for training a palm print recognition model 121. The palm print recognition model 121 is configured for performing palm print recognition. The palm print generation model is a model obtained by training the gathered palm print images. Therefore, the sample palm print images are large in quantity and have high accuracy. The palm print recognition model 121 is trained by using the sample palm print images, and further, the palm print is recognized by using the trained palm print recognition model, thereby improving accuracy of palm print recognition.

The foregoing terminal includes, but is not limited to, a mobile terminal such as a mobile phone, a tablet computer, a portable laptop computer, an intelligent voice interaction device, an intelligent appliance, or an in-vehicle terminal, or may be implemented as a desktop computer or the like. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology refers to a hosting technology that implements calculation, storage, processing, and sharing of data by unifying a series of resources such as hardware, an application, and a network in a wide area network or a local area network. The cloud technology is a collective name of a network technology, an information technology, an integration technology, a platform management technology, an application technology, and the like based on an application of a cloud computing business mode, and may form a resource pool, which is used as required, and is flexible and convenient.

In some embodiments, the server may alternatively be implemented as a node in a blockchain system.

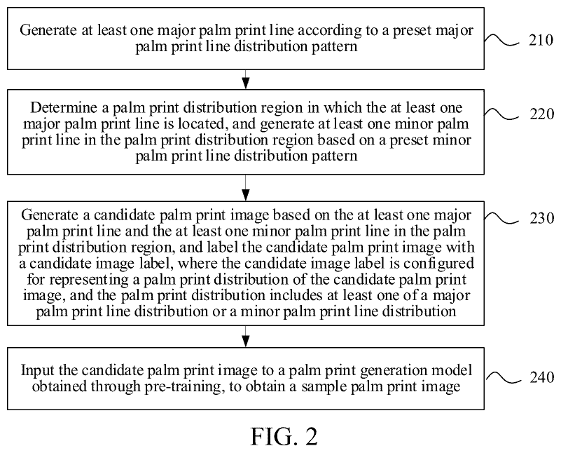

The method for generating a sample palm print image provided in this application is described with reference to the foregoing introduction to nouns and application scenes. An example in which the method is applied to a server is used. As shown in FIG. 2, the method includes the following operations 210 to 240.

Operation 210: Generate at least one major palm print line according to a preset major palm print line distribution pattern.

The major palm print line distribution pattern is a description about how major lines in a palm print are distributed, and is configured for indicating distribution of the major lines in the palm print. The major palm print line distribution pattern may include a position pattern and a direction pattern of the major lines in the palm print. The position pattern describes positions of the major lines in the palm print, and the direction pattern describes trends of extension of the major lines in the palm print. The major palm print line distribution pattern may be obtained by summarizing a palm print of a living creature through artificial or artificial intelligence means. The major palm print line distribution pattern may be referred to as a major palm print line distribution mode or a major palm print line distribution manner.

The minor palm print line distribution pattern is a description about how minor lines in a palm print are distributed, and is configured for indicating distribution of the minor lines in the palm print. The minor palm print line distribution pattern may include a position pattern and a direction pattern of the minor lines in the palm print. The position pattern describes positions of the minor lines in the palm print, and the direction pattern describes trends of extension of the minor lines in the palm print. The minor palm print line distribution pattern may be obtained by summarizing a palm print of a living creature through artificial or artificial intelligence means. The minor palm print line distribution pattern may be referred to as a minor palm print line distribution mode or a minor palm print line distribution manner.

In some embodiments, after palm prints of palms of a large number of living creatures are analyzed, it is determined that the palm prints of the palm mainly include a major palm print line and a minor palm print line. Common features of the palm prints of the palm include at least one of the following: (1) Distribution of the major palm print line is relatively certain, and distribution of the minor palm print line is relatively random. (2) The major palm print line usually has longer, thicker, and deeper texture features in the palm print. Compared with the major palm print line, the minor palm print line has thinner, shorter, and shallower texture features.

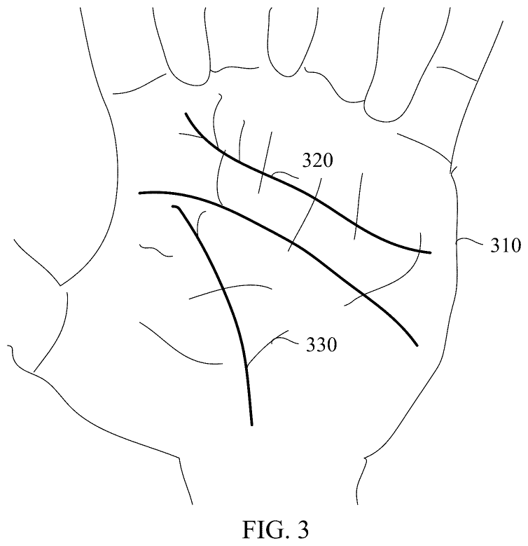

In some embodiments, when the palm print is a palm print of a palm, distribution of the major palm print line is usually presented in a diagonal relationship. To be specific, a major palm print line distribution pattern of the palm is a diagonal pattern. Schematically, using a left palm as an example, a major palm print line usually starts at an upper left corner and ends at a lower right corner. Using a right palm as an example, a major palm print line usually starts at an upper right corner and ends at a lower left corner. FIG. 3 is a schematic diagram showing a palm print of a left palm. A palm region 310 includes a major line 320 and a minor line 330. A relatively thick line is configured for indicating the major line 320, and a relatively thin line is configured for indicating the minor line 330. To be specific, the palm region 310 includes three major lines 320 and 13 minor lines 330.

In some embodiments, at least one major palm print line is generated based on a major palm print line distribution pattern within a preset major palm print line quantity range.

Schematically, the major palm print line quantity range is a quantity range determined based on analyzing palm prints of palms of a large number of living creatures. For example, based on observation of palm print data of a living creature, there are usually two to five major palm print lines.

In an exemplary embodiment, positioning point data is generated according to the preset major palm print line distribution pattern.

The positioning point data includes first data corresponding to a first major line positioning point and second data corresponding to a second major line positioning point.

The positioning point data is configured for indicating a fixed condition of the major line, and includes the first data and the second data. A starting condition and an ending condition of the major line are determined based on the first data and the second data, and distribution of the major line is approximately determined. Schematically, the first data corresponds to the first major line positioning point. The second data corresponds to the second major line positioning point.

In some embodiments, a starting point of the major palm print line is used as the first major line positioning point, and an ending point of the major palm print line is used as the second major line positioning point.

In an exemplary embodiment, adjustment point data is generated according to a major palm print line radian pattern.

A major line adjustment point corresponding to the adjustment point data is configured for controlling a radian of a major line formed by the first major line positioning point and the second major line positioning point.

The major palm print line radian pattern is configured for indicating a radian condition of the major line in the palm print. Schematically, the major palm print line is usually not a straight line segment, but a curve having a particular radian. After the first major line positioning point and the second major line positioning point are determined, the radian of the major line formed by the first major line positioning point and the second major line positioning point is adjusted by using the generated major line adjustment point.

In an exemplary embodiment, adjustment point data is determined in a region between the first major line positioning point and the second major line positioning point according to the major palm print line radian pattern.

Schematically, a geometrical appearance of the palm print is described parametrically by using a Bezier curve. In some embodiments, the major palm print line is described by using at least one Bezier curve.

The Bezier curve is a mathematical curve applied to a two-dimensional graphic application. The Bezier curve includes a line segment and a node. The node is a draggable fulcrum. The line segment is similar to a retractable rubber band. When a shape of the line segment is controlled, a radian of the line segment is controlled by using the node, to obtain a corresponding curve.

In some embodiments, any major palm print line is used as an example for description. A second-order Bezier curve is configured for forming the major palm print line. To be specific, a major palm print line (Bezier curve) is determined by using three pieces of data (parameter points) in a 2-dimensional (2D) plane. The three pieces of data are respectively first data representing the first major line positioning point, a major line adjustment point, and second data representing the second major line positioning point.

In an exemplary embodiment, the major palm print line is generated based on the first data, the second data, and the adjustment point data. The major palm print line is a curve sequentially connecting the first major line positioning point, the major line adjustment point, and the second major line positioning point.

The foregoing is merely an illustrative example. This is not limited in this embodiment of this application.

Operation 220: Determine a palm print distribution region in which the at least one major palm print line is located, and generate at least one minor palm print line in the palm print distribution region based on a preset minor palm print line distribution pattern.

Schematically, after at least one major palm print line is generated, a palm print distribution region in which the at least one major palm print line is located is determined. The palm print distribution region is preset and can include the at least one major palm print line. Specifically, the palm print distribution region in which the at least one major palm print line is contained may be determined on a plane in which the at least one major palm print line is located according to a shape of the preset palm print distribution region. There may be a major palm print line connected to a boundary of the palm print distribution region in the at least one major palm print line, or a distance between each major palm print line of the at least one major palm print line and the boundary of the palm print distribution region is not greater than a preset distance.

For example, after a major palm print line is generated, the major palm print line is used as a diagonal line, and a rectangular region that can include the major palm print line is obtained as a palm print distribution region. Alternatively, after a plurality of major palm print lines are generated, a region that can include the plurality of major palm print lines is used as the palm print distribution region. The region may be a regular rectangular region, or may be any irregular region.

In some embodiments, a palm print generation region is preset, at least one major palm print line is generated in the palm print generation region, and the palm print generation region is used as the palm print distribution region.

The minor palm print line distribution pattern is configured for indicating distribution of the minor lines in the palm print.

In some embodiments, after palm prints of palms of a large number of living creatures are analyzed, it is determined that the palm prints of the palm include a minor palm print line in addition to a major palm print line. For example, compared with the major palm print line of which distribution is relatively certain, distribution of the minor palm print line is relatively random. Compared with a longer, thicker, and deeper major palm print line, the minor palm print line has thinner, shorter, and shallower texture features.

At least one minor palm print line is generated in the palm print distribution region based on a minor palm print line distribution pattern.

In some embodiments, the minor palm print line distribution pattern includes distribution patterns such as a minor palm print line length pattern, a minor palm print line thickness pattern, and a minor palm print line density pattern.

Schematically, the minor palm print line length pattern is configured for indicating a length limitation of the minor palm print line. For example, the length of the minor palm print line is less than a shortest major palm print line of the plurality of major palm print lines. Alternatively, the length of the minor palm print line is less than a preset length threshold (for example, 3 centimeters).

Schematically, the minor palm print line thickness pattern is configured for indicating a thickness limitation of the minor palm print line. For example, a thickness of the minor palm print line is less than a thinnest major palm print line of the plurality of major palm print lines. Alternatively, the thickness of the minor palm print line is less than a preset thickness threshold (for example, 1 millimeter).

Schematically, the minor palm print line density pattern is configured for indicating mutual distribution of at least two minor palm print lines in the palm print generation region. For example, it is specified that at least three minor palm print lines are generated in a predetermined X region (preset region) in the palm print generation region. Alternatively, the palm print generation region is divided into a plurality of sub-regions of a unit length (1 centimeter), and it is specified that each sub-region is required to have at least two minor palm print lines.

The foregoing plurality of distribution patterns may be independently applied, or may be applied in combination. For example, a minor palm print line is determined only by using the length pattern. Alternatively, the length pattern, the thickness pattern, and the density pattern are comprehensively considered, to determine the minor palm print line and the like. The foregoing is merely an illustrative example. This is not limited in this embodiment of this application.

Operation 230: Generate a candidate palm print image based on the at least one major palm print line and the at least one minor palm print line in the palm print distribution region, and label the candidate palm print image with a candidate image label, where the candidate image label is configured for representing a palm print distribution of the candidate palm print image, and the palm print distribution includes at least one of a major palm print line distribution or a minor palm print line distribution.

The palm print distribution includes at least one of a major palm print line distribution or a minor palm print line distribution.

Schematically, after at least one major palm print line and at least one minor palm print line are obtained, a palm print distribution region including the at least one major palm print line and the at least one minor palm print line is used as a candidate palm print image. In some embodiments, the candidate palm print image may be generated after the palm print distribution region of the at least one major palm print line and the at least one minor palm print line is further processed. The further processing is, for example, extending a preset amplitude from an edge of the palm print distribution region, or adding noise.

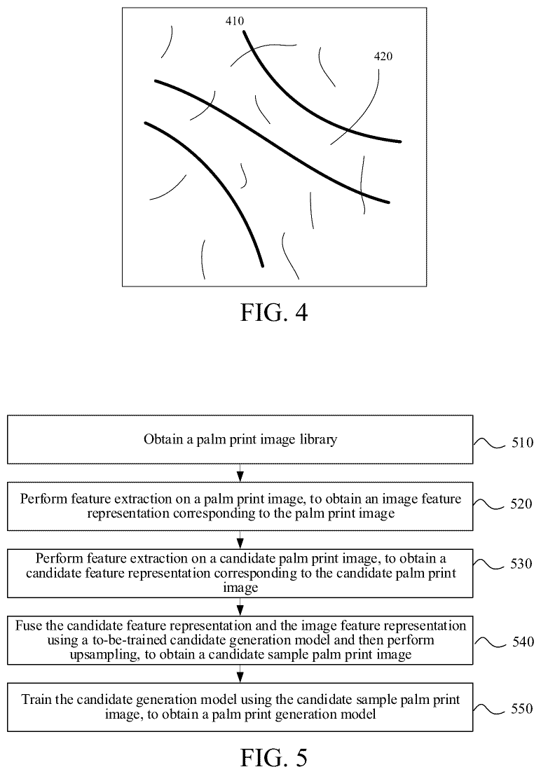

For example, as shown in FIG. 4, three major palm print lines 410 (long line segments that are bold in FIG. 4) have been generated according to the preset major palm print line distribution pattern, and in a palm print distribution region in which the three major palm print lines are located, 11 minor palm print lines 410 (short line segments that are not bold in FIG. 4) have been generated based on the preset minor palm print line distribution pattern. A region including the three major palm print lines and the 11 minor palm print lines is used as the candidate palm print image. To be specific, an image shown in FIG. 4 is used as the candidate palm print image.

The candidate palm print image is labeled with a candidate image label, and the candidate image label is configured for representing a palm print distribution of the candidate palm print image.

The palm print distribution includes at least one of a major palm print line distribution or a minor palm print line distribution. The major palm print line distribution may include description information of each major palm print line and a relative position relationship of a plurality of major palm print lines. The description information of each major palm print line may include position description information that describes a position of the major palm print line or direction description information that describes a direction of the major palm print line. The minor palm print line distribution may include description information of each minor palm print line and a relative position relationship of a plurality of minor palm print lines. The description information of each minor palm print line may include position description information that describes a position of the minor palm print line or direction description information that describes a direction of the minor palm print line.

In some embodiments, after a candidate palm print image is generated, a major palm print line distribution in the candidate palm print image is determined. A candidate image label corresponding to the candidate palm print image is determined based on the major palm print line distribution. The major palm print line distribution includes at least one of the following cases:

(1) The major palm print line distribution is determined according to a relative position relationship between the first major line positioning point and the second major line positioning point in the major palm print line.

Schematically, after at least one major palm print line is obtained, a first major line positioning point and a second major line positioning point that respectively correspond to each major palm print line are determined. When distribution of a target major palm print line of the at least one major palm print line is determined, a first position of the first major line positioning point in the target major palm print line in the palm print distribution region is determined, a second position of the second major line positioning point in the target major palm print line in the palm print distribution region is determined, and a relative position relationship between the first position and the second position in the palm print distribution region is determined, thereby obtaining a relative position relationship corresponding to the target major palm print line. Based on this method, a relative position relationship respectively corresponding to the at least one major palm print line is determined.

In some embodiments, the major palm print line distribution corresponding to the candidate palm print image is determined in combination with the relative position relationship respectively corresponding to the at least one major palm print line.

(2) The major palm print line distribution is determined according to a relative relationship between major line positions of a plurality of major palm print lines.

Schematically, when the obtained candidate palm print image includes a plurality of major palm print lines, major line positions respectively corresponding to the plurality of major palm print lines in the palm print distribution region are determined, to obtain a plurality of major line positions. A relative position relationship of the plurality of major line positions is determined in the palm print distribution region. For example, a major line position A corresponding to a major palm print line 1 and a major line position B corresponding to a major palm print line 2 tend to be parallel. The major line position A corresponding to the major palm print line 1 and a major line position C corresponding to a major palm print line 3 tend to be in a herringbone state or the like.

In some embodiments, the major palm print line distribution corresponding to the candidate palm print image is determined in combination with the relative position relationship of the plurality of major line positions.

In some embodiments, after a candidate palm print image is generated, a minor palm print line distribution in the candidate palm print image is determined. A candidate image label corresponding to the candidate palm print image is determined based on the minor palm print line distribution.

Schematically, the minor palm print line distribution is determined according to a relative position relationship of a plurality of minor palm print lines. Alternatively, the minor palm print line distribution is determined according to a cross relationship of a plurality of minor palm print lines.

In some embodiments, after a candidate palm print image is generated, a major palm print line distribution and a minor palm print line distribution in the candidate palm print image are determined. A candidate image label corresponding to the candidate palm print image is determined based on the major palm print line distribution and the minor palm print line distribution.

Schematically, the palm print distribution corresponding to the candidate palm print image is configured for indicating identity (ID) information indicated by the candidate palm print image. To be specific, the candidate image label indicating the palm print distribution can distinguish a plurality of candidate palm print images.

In some embodiments, after a plurality of candidate palm print images are generated, the candidate palm print images are labeled with candidate image labels in combination with the major palm print line distribution and the minor palm print line distribution. For any two candidate palm print images, if there is a difference between any one of content such as a position and a length of a major palm print line or a minor palm print line, candidate image labels are different, so that the plurality of candidate palm print images can be distinguished.

In some embodiments, a distribution change range is preset, where the distribution change range includes a major palm print line distribution change range and a minor palm print line distribution change range. Different candidate image labels are labeled when the major palm print line distribution goes beyond the major palm print line distribution change range. Alternatively, different candidate image labels are labeled when the minor palm print line distribution goes beyond the minor palm print line distribution change range. Alternatively, different candidate image labels are labeled when the major palm print line distribution goes beyond the major palm print line distribution change range and the minor palm print line distribution goes beyond the minor palm print line distribution change range.

The foregoing is merely an illustrative example. This is not limited in this embodiment of this application.

Operation 240: Input the candidate palm print image to a palm print generation model obtained through pre-training, to obtain a sample palm print image.

The palm print generation model is a model obtained through pre-training by using a palm print image label of a pre-gathered palm print image and the candidate image label.

The palm print image is configured for representing an image having a palm print texture feature. In some embodiments, the palm print image is one pre-gathered image. Alternatively, the palm print images are a plurality of pre-gathered images.

In some embodiments, the palm print image is labeled with a palm print image label, and the palm print image label is configured for indicating a palm print distribution of the palm print image.

The palm print distribution includes at least one of a major palm print line distribution or a minor palm print line distribution. The palm print distribution corresponding to the palm print image is configured for indicating an ID indicated by the palm print image.

In some embodiments, the major palm print line is determined at least by using a major palm print line starting point of the major palm print line, a major palm print line ending point of the major palm print line, and a radian of the major palm print line, and at least one major palm print line distribution is used as the palm print image label corresponding to the palm print image.

Schematically, when a plurality of major palm print lines exists in the palm print image, a palm print image label corresponding to the palm print image is determined according to a starting point of a longest major palm print line, an ending point of the major palm print line, and a radian of the major palm print line. Alternatively, when a plurality of major palm print lines exists in the palm print image, a palm print image label corresponding to the palm print image is determined in combination with major palm print line starting points, major palm print line ending points, and radians of the major palm print lines that respectively correspond to the plurality of major palm print lines.

In some embodiments, at least one minor palm print line distribution is used as the palm print image label corresponding to the palm print image.

Schematically, in addition to indicating distribution of a major palm print line, the palm print image label is further configured for indicating distribution of a plurality of minor palm print lines in the palm print image, for example, a position relationship of the minor palm print line in the palm print image, or the quantity of minor palm print lines in the palm print image.

In some embodiments, at least one minor palm print line distribution and at least one major palm print line distribution are used as palm print image labels corresponding to the palm print image.

The sample palm print image is configured for training a palm print recognition model. The palm print recognition model is configured for performing palm print recognition.

Schematically, after the candidate palm print image is adjusted, a sample palm print image that better conforms to a palm print distribution pattern in the gathered palm print image is obtained.

In some embodiments, the sample palm print image is configured for training a to-be-trained palm print recognition model. Alternatively, after the sample palm print image is mixed with a plurality of palm print images in a palm print image library, the to-be-trained palm print recognition model is trained by using a plurality of images (including the sample palm print image and the plurality of palm print images). Alternatively, after the sample palm print image is configured for training the to-be-trained palm print recognition model for the first time, the plurality of palm print images in the palm print image library are configured for training the palm print recognition model after the first training, thereby improving robustness of the palm print recognition model.

The foregoing is merely an illustrative example. This is not limited in this embodiment of this application.

In conclusion, because a candidate palm print image is an image obtained based on a major palm print line distribution pattern and a minor palm print line distribution pattern, the candidate palm print image has characteristics of large quantity and diversity. In addition, to make the candidate palm print image more consistent with an image of a real palm print, a palm print generation model is obtained through pre-training by using a palm print image label of a pre-gathered palm print image and a candidate image label, and a sample palm print image corresponding to the candidate palm print image is generated by using the palm print generation model, so that a palm print distribution in the sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

In an exemplary embodiment, the palm print generation model is a model obtained after performing model training on a candidate generation model. Schematically, as shown in FIG. 5, a process of performing model training on a candidate generation model to obtain the palm print generation model may be implemented as the following operations 510 to 550.

Operation 510: Obtain a palm print image library.

The palm print image library pre-stores a plurality of gathered palm print images, and the plurality of palm print images are respectively labeled with palm print image labels.

Schematically, the plurality of palm print images are pre-gathered images that have a palm print texture feature. For example, the palm print image library stores a palm print image a1 and a palm print image a2 of an object A. For example, the palm print image a1 of the object A is a left-hand palm print image of the object A, and the palm print image a2 of the object A is a right-hand palm print image of the object A. The palm print image library further stores a palm print image b1 and a palm print image b2 of an object B. For example, the palm print image b1 of the object B is a left-hand palm print image of the object B, and the palm print image b2 of the object B is another left-hand palm print image of the object B.

The plurality of palm print images are respectively labeled with a palm print image label, and the palm print image label is configured for indicating a palm print distribution of the palm print image.

Operation 520: Perform feature extraction on a palm print image, to obtain an image feature representation corresponding to the palm print image.

Schematically, an image feature representation respectively corresponding to at least one palm print image is obtained. For example, feature extraction is performed on the at least one palm print image by using an encoder, to obtain the image feature representation respectively corresponding to the at least one palm print image.

Operation 530: Perform feature extraction on a candidate palm print image, to obtain a candidate feature representation corresponding to the candidate palm print image.

Schematically, after a candidate palm print image is obtained, the candidate palm print image is downsampled, to obtain a candidate feature representation corresponding to the candidate palm print image. Alternatively, feature extraction is performed on the candidate palm print image by using the encoder, to obtain the candidate feature representation corresponding to the candidate palm print image.

In some embodiments, feature extraction is performed on the candidate palm print image by using a to-be-trained candidate generation model, to obtain the candidate feature representation corresponding to the candidate palm print image.

Operation 540: Fuse the candidate feature representation and the image feature representation using a to-be-trained candidate generation model and then perform upsampling, to obtain a candidate sample palm print image.

In some embodiments, feature fusion processing is performed on the candidate feature representation and the image feature representation using the candidate generation model, to obtain a fused feature representation.

The fused feature representation is configured for representing a feature representation obtained after constraint adjustment is performed on the candidate feature representation by using at least one image feature representation.

Schematically, a bitwise dot product operation is performed on the candidate feature representation and the image feature representation, to obtain the fused feature representation. For example, a feature dimension of the image feature representation is 64, and a feature dimension of the candidate feature representation is also 64. Therefore, a feature dimension of the fused feature representation is 64.

In some embodiments, feature fusion processing is respectively performed on the candidate feature representation by using the at least one image feature representation, to obtain the fused feature representation respectively corresponding to the at least one image feature representation. To be specific, at least one fused feature representation is obtained.

In some embodiments, feature fusion processing is performed on the plurality of image feature representations and the candidate feature representation, to obtain one fused feature representation. The fused feature representation is configured for representing a result of adjusting the candidate feature representation by using the plurality of image feature representations.

In some embodiments, the fused feature representation is upsampled, to obtain a candidate sample palm print image.

In some embodiments, after the fused feature representation is obtained, the size of the at least one fused feature representation is restored through an upsampling process, to obtain a sample palm print image respectively corresponding to the at least one fused feature representation.

Operation 550: Train the candidate generation model using the candidate sample palm print image, to obtain a palm print generation model.

In an exemplary embodiment, a candidate palm print image corresponding to the candidate sample palm print image is determined, and a candidate image label corresponding to the candidate palm print image is used as a sample image label of the candidate sample palm print image.

Schematically, the candidate sample palm print image is an image obtained based on the candidate feature representation and the image feature representation. Therefore, the candidate sample palm print image corresponds to a candidate palm print image corresponding to the candidate feature representation. For example, a candidate sample palm print image A is an image obtained based on a candidate feature representation a1 and an image feature representation b1. Therefore, the candidate sample palm print image corresponds to a candidate palm print image A1 corresponding to the candidate feature representation a1.

In some embodiments, based on a correspondence between a candidate sample palm print image and a candidate palm print image, a candidate image label of the candidate palm print image corresponding to the candidate sample palm print image is determined, and the candidate image label is used as a sample image label of the candidate sample palm print image.

Schematically, a candidate image label of a candidate palm print image A1 corresponding to a candidate sample palm print image A is a “label a,” and the “label a” is used as a sample image label of the candidate sample palm print image.

In an exemplary embodiment, a loss value corresponding to the candidate sample palm print image is obtained based on a distribution difference between a palm print distribution indicated by the sample image label and a palm print distribution indicated by the palm print image label.

Schematically, loss values respectively corresponding to the sample image label and the at least one palm print image label are calculated.

For example, a first image feature representation corresponding to the sample image label and a second image feature representation respectively corresponding to the at least one palm print image are obtained, and a loss value respectively corresponding to the at least one palm print image label is obtained based on a vector distance between the first image feature representation and the second image feature representation in a vector space.

In an exemplary embodiment, the candidate generation model is trained by using the loss value, to obtain the palm print generation model.

Schematically, the candidate generation model is trained by using at least one loss value until training of the candidate generation model reaches a training condition, to obtain the palm print generation model.

The palm print generation model is configured for generating a sample palm print image. To be specific, the palm print generation model is used in a process of generating the sample palm print image.

In conclusion, a palm print generation model is obtained through pre-training by using a palm print image label of a pre-gathered palm print image and a candidate image label, and a sample palm print image corresponding to the candidate palm print image is generated by using the palm print generation model, so that a palm print distribution in the sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

In this embodiment of this application, a model training process of performing model training on a candidate generation model, to obtain a palm print generation model for generating a sample palm print image is described. Upsampling is performed after an image feature representation corresponding to a pre-obtained palm print image is fused with a candidate feature representation of a candidate palm print image, to obtain a candidate sample palm print image obtained after constraint adjustment is performed on the candidate feature representation by using at least one image feature representation. Compared with a candidate palm print image not adjusted by using the palm print image, the candidate sample palm print image is closer to a palm print texture feature of the pre-obtained palm print image. Further, the candidate generation model is trained by using the candidate sample palm print image, so that a palm print generation model with higher robustness can be obtained, thereby facilitating generation of a more accurate sample palm print image with higher trueness.

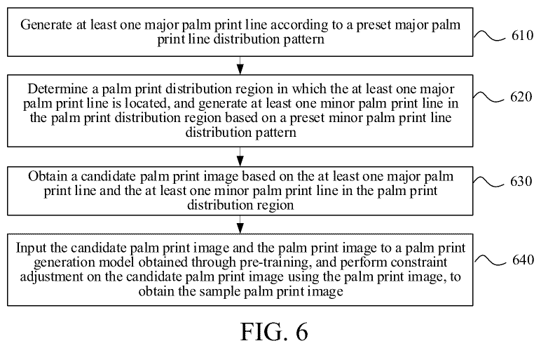

In an exemplary embodiment, in addition to that the sample palm print image may be directly obtained based on the palm print generation model obtained through pre-training, constraint adjustment may be performed on the candidate palm print image by using the palm print image with the aid of a label association relationship between image labels respectively corresponding to the gathered palm print image and the generated candidate palm print image, to obtain the sample palm print image. Schematically, the gathered palm print image and the generated candidate palm print image are jointly inputted to the palm print generation model, as shown in FIG. 6, which may further be implemented as the following operations 610 to 640.

Operation 610: Generate at least one major palm print line according to a preset major palm print line distribution pattern.

In some embodiments, the palm print may be implemented as a palm print of a palm. Distribution of a major palm print line in the palm print is usually presented as a diagonal relationship. To be specific, a major palm print line distribution pattern of the palm is a diagonal pattern.

In some embodiments, the palm print may alternatively be implemented as a palm print of a sole. Distribution of a major palm print line in the palm print of the sole is usually presented in various palm print forms such as herringbone forms, a turtle form, and a vertical form. A major palm print line distribution pattern of the sole may be determined with reference to several common forms.

In an exemplary embodiment, positioning point data is generated according to the preset major palm print line distribution pattern.

The positioning point data includes first data corresponding to a first major line positioning point and second data corresponding to a second major line positioning point.

In an exemplary embodiment, a starting point of the major palm print line is used as the first major line positioning point, and an ending point of the major palm print line is used as the second major line positioning point. Schematically, the positioning point data may be generated in at least one of the following modes.

### (1) Random Generation Mode

Schematically, in any coordinate region, first data and second data are generated in a random generation mode. The coordinate region is equally scaled with a line segment connected between the first major line positioning point and the second major line positioning point according to a length limitation of the major palm print line, to determine the first major line positioning point corresponding to the first data and the second major line positioning point corresponding to the second data.

### (2) Generation Mode in Subregion

In some embodiments, a preset distribution region of a major palm print line is used as an example for description. In the distribution region of the major palm print line, the distribution region is divided, to obtain one or more subregions, and the first data and the second data are generated in the subregion in a random generation mode. For example, two subregions are obtained after the distribution region is divided. A first major line positioning point corresponding to the first data is generated in a first subregion, and a second major line positioning point corresponding to the second data is generated in a second subregion.

In some embodiments, a plurality of subregions are obtained after the distribution region is divided, and a sum of regions of the plurality of subregions may be implemented as the whole distribution region, or may be implemented as the partial distribution region. To be specific, the subregion for generating the positioning point data may include the entire distribution region, may include only part of the distribution region, or the like. In this disclosure, when the subregion includes the entire distribution region, it means the “division” is nominal and no actual division is performed.

The foregoing is merely an illustrative example. This is not limited in this embodiment of this application.

In an exemplary embodiment, adjustment point data is generated according to a major palm print line radian pattern.

A major line adjustment point corresponding to the adjustment point data is configured for controlling a radian of a major line formed by the first major line positioning point and the second major line positioning point.

In an exemplary embodiment, adjustment point data is determined in a region between the first major line positioning point and the second major line positioning point according to the major palm print line radian pattern.

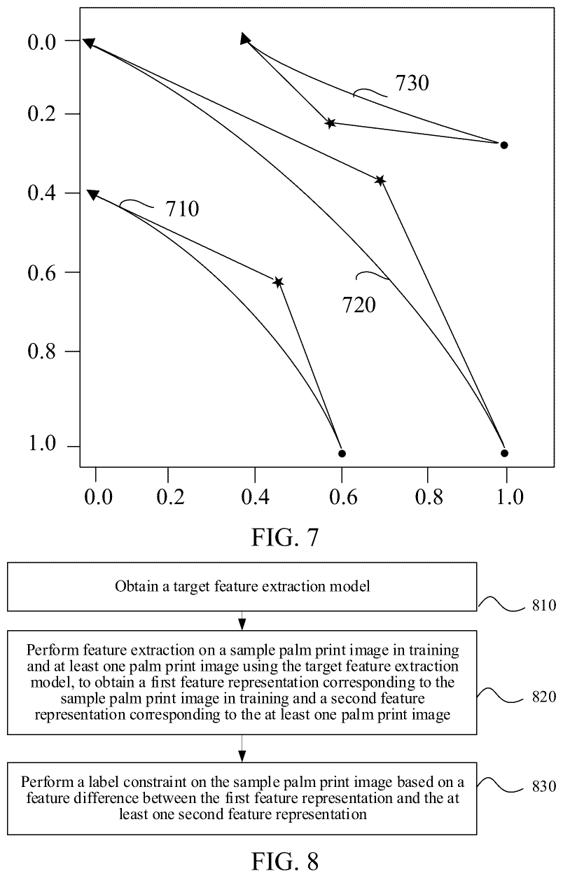

Schematically, FIG. 7 is a schematic diagram showing determination of a major palm print line by using a Bezier curve method. A region formed by a horizontal axis and a vertical axis is a generation region of the major palm print line, and numbers labeled on the horizontal axis and the vertical axis are configured for assisting in determination of coordinate positions of three pieces of data. The schematic diagram includes three major palm print lines. Each major palm print line is determined by using first data, a major line adjustment point, and second data, and an “inverted triangular symbol” is configured for indicating a first major line positioning point corresponding to the first data. A “star symbol” is configured for indicating a major line adjustment point. A “circle symbol” is configured for indicating a second major line positioning point corresponding to the second data.

Schematically, the first major line positioning point corresponding to the first data and the second major line positioning point corresponding to the second data are first generated. Then, the major line adjustment point is generated between the first major line positioning point and the second major line positioning point. In some embodiments, the major line adjustment point is generated based on a restriction relationship in a coordinate region of the first major line positioning point and the second major line positioning point.

For example, coordinates of a first major line positioning point of a major palm print line 710 are (0.0, 0.4), coordinates of a major line adjustment point are (0.5, 0.6), and coordinates of a second major line positioning point are (0.6, 1.0). Coordinates of a first major line positioning point of a major palm print line 720 are (0.0, 0.0), coordinates of a major line adjustment point are (0.5, 0.3), and coordinates of a second major line positioning point are (1.0, 1.0). Coordinates of a first major line positioning point of a major palm print line 730 are (0.3, 0.0), coordinates of a major line adjustment point are (0.6, 0.3), and coordinates of a second major line positioning point are (1.0, 0.3).

In an exemplary embodiment, at least one major palm print line is generated based on the first data, the second data, and the adjustment point data.

The major palm print line is a curve sequentially connecting the first major line positioning point, the major line adjustment point, and the second major line positioning point.

Schematically, as shown in FIG. 7, the major palm print line 710 is obtained by sequentially connecting the first major line positioning point, the major line adjustment point, and the second major line positioning point, so that the major palm print line 710 presents an arc-shaped curve protruding upwards at a large amplitude. The major palm print line 720 is obtained by sequentially connecting the first major line positioning point, the major line adjustment point, and the second major line positioning point, so that the major palm print line 720 presents an arc-shaped curve protruding upwards at a small amplitude. The major palm print line 730 is obtained by sequentially connecting the first major line positioning point, the major line adjustment point, and the second major line positioning point, so that the major palm print line 730 presents an arc-shaped curve recessed downwards.

Operation 620: Determine a palm print distribution region in which the at least one major palm print line is located, and generate at least one minor palm print line in the palm print distribution region based on a preset minor palm print line distribution pattern.

In some embodiments, the palm print distribution region in which the major palm print line is located is determined after the at least one major palm print line is generated. Alternatively, after the palm print distribution region in which the major palm print line is located is predetermined, at least one major palm print line is generated in the palm print distribution region, and the palm print distribution region is a palm print distribution region in which the at least one major palm print line is located.

In an exemplary embodiment, after the at least one major palm print line is generated in the palm print distribution region, at least one minor palm print line is generated based on a preset minor palm print line distribution pattern. Alternatively, in the palm print distribution region, at least one major palm print line is generated based on the major palm print line distribution pattern, and at least one minor palm print line is generated based on the preset minor palm print line distribution pattern.

The minor palm print line distribution pattern is configured for indicating distribution of the minor lines in the palm print.

Schematically, after three major palm print lines are generated in the palm print distribution region, 13 minor palm print lines are generated based on the preset minor palm print line distribution pattern. Alternatively, a major palm print line and a minor palm print line are generated based on both the major palm print line distribution pattern and the minor palm print line distribution pattern, and a total of four major palm print lines and 22 minor palm print lines are generated.

In some embodiments, the major palm print line and the minor palm print line may intersect with each other. In addition, the major palm print lines may intersect with each other. In addition, the minor palm print lines may intersect with each other.

In an exemplary embodiment, in the palm print distribution region in which the at least one major palm print line is located, a plurality of minor palm print line positioning points are determined based on the minor palm print line distribution pattern.

The minor palm print line positioning point is configured for determining a generation range of a minor line. For example, at least two minor palm print line positioning points are generated according to the minor palm print line distribution pattern.

In some embodiments, the minor palm print line distribution pattern includes distribution patterns such as a length pattern, a thickness pattern, and a density pattern of the minor palm print line, and the distribution patterns may be applied separately or in combination. For example, a minor palm print line is determined only by using the length pattern. Alternatively, the length pattern, the thickness pattern, and the density pattern are comprehensively considered, to determine the minor palm print line and the like.

In some embodiments, in the palm print distribution, distribution of the minor palm print line is relatively scattered and random. Based on the minor palm print line distribution pattern and a palm print distribution of palm print data stored in a palm print database, at least one minor palm print line is generated in the palm print generation region by using at least one of the following methods.

(1) After at least one minor palm print line positioning point is determined, at least one remaining minor palm print line positioning point is determined based on the minor palm print line distribution pattern.

Schematically, it is predetermined that a preset length threshold of the minor palm print line is 3 centimeters and a preset thickness threshold of the minor palm print line is 1 millimeter. A minor palm print line positioning point is randomly generated in the palm print generation region, and at least one remaining minor palm print line positioning point is determined within the preset length threshold and the preset thickness threshold of the minor palm print line, to obtain at least two minor palm print line positioning points. In some embodiments, the at least one remaining minor palm print line positioning point is used as a reference, and remaining minor palm print line positioning points are determined within the preset length threshold and the preset thickness threshold of the minor palm print line.

(2) At least two minor palm print line positioning points are randomly determined.

Schematically, in the palm print generation region, at least two points are randomly generated as at least two minor palm print line positioning points based on the minor palm print line distribution pattern. Alternatively, at least two sub-regions are obtained after the palm print generation region is divided, and minor palm print line positioning points for generating a minor palm print line are determined in the sub-regions.

In an exemplary embodiment, at least one minor palm print line is generated based on a plurality of minor palm print line positioning points.

In some embodiments, after at least two minor palm print line positioning points are obtained, a mode of obtaining a minor palm print line includes at least one of the following.

1. Connect at least two minor palm print line positioning points of a plurality of minor palm print line positioning points, to obtain at least one minor palm print line.

Schematically, after the plurality of generated minor palm print line positioning points are obtained, any two minor palm print line positioning points are connected, to obtain a minor palm print line in a form of a line segment. Alternatively, a minor palm print line in a shape of an irregular line segment is obtained after connecting any plurality of minor palm print line positioning points. Alternatively, when a minor line length is considered to be small, any plurality (two or more) of minor palm print line positioning points are used as a minor line positioning point group, and a minor palm print line or the like is obtained within a particular length range.

2. Determine at least one palm print sample according to a minor palm print line adjustment point generated by using a plurality of minor palm print line positioning points.

In an exemplary embodiment, the minor palm print line adjustment point is determined based on at least two minor palm print line positioning points.

The minor palm print line adjustment point is configured for controlling a radian between at least two minor palm print line positioning points of the plurality of minor palm print line positioning points.

Schematically, when a minor palm print line is generated, the minor palm print line is determined by using a Bezier curve method. To be specific, after at least two minor palm print line positioning points are generated, a minor palm print line adjustment point that adjusts a line segment radian between the at least two minor palm print line positioning points is determined, and a process of moving a position of the minor palm print line adjustment point is performed, to obtain different minor palm print lines corresponding to the minor palm print line adjustment point at different positions. For example, the minor palm print lines are in a form of an arc having a large radian, or in a form of an irregular curve having a small bending amplitude.

In an exemplary embodiment, a minor palm print line is determined based on at least two minor palm print line positioning points and the minor palm print line adjustment point within a preset minor palm print line quantity range.

In some embodiments, to make a palm print condition in the generated palm print sample similar to a palm print condition of a living creature, quantities of major palm print lines and minor palm print lines are preset. Schematically, an observation result in a palm region is used as an example for description. In a case of a palm print of a living creature, in the palm region, the quantity of major palm print lines is 2 to 5, and the quantity of minor palm print lines is 5 to 15. For example, the quantity of major palm print lines is preset to be 2 to 5, the quantity of minor palm print lines is preset to be 5 to 15, and when the major palm print lines are determined, the quantity of major palm print lines is controlled to be within the range of 2 to 5, to obtain major palm print lines in at most four cases. When the minor palm print lines are determined, the quantity of minor palm print lines is controlled to be within the range of 5 to 15, to obtain minor palm print lines in at most eleven cases.

The foregoing is merely an illustrative example. This is not limited in this embodiment of this application.

Operation 630: Generate a candidate palm print image based on the at least one major palm print line and the at least one minor palm print line in the palm print distribution region, and label the candidate palm print image with a candidate image label, where the candidate image label is configured for representing a palm print distribution of the candidate palm print image, and the palm print distribution includes at least one of a major palm print line distribution or a minor palm print line distribution.

In an exemplary embodiment, a candidate palm print image including major palm print lines and minor palm print lines is generated within a preset palm print quantity range.

The palm print quantity range includes at least one of a major palm print line quantity range or a minor palm print line quantity range. In some embodiments, the candidate palm print image includes a particular quantity of major palm print lines and minor palm print lines. When a palm print sample is obtained based on a palm print condition of a living creature, the quantity of major palm print lines and the quantity of minor palm print lines in the palm print sample are similar to the quantity of major palm print lines and the quantity of minor palm print lines of the living creature.

Schematically, in a certain palm region, the quantity of major palm print lines is controlled to be 2 to 5, and the quantity of minor palm print lines is controlled to be 5 to 15, to obtain a plurality of candidate palm print images. For example, the quantity of major palm print lines in a first candidate palm print image is 3, and the quantity of minor palm print lines is 12. The quantity of major palm print lines in a second candidate palm print image is 5, and the quantity of minor palm print lines is 10. The quantity of major palm print lines in a third candidate palm print image is 4, and the quantity of minor palm print lines is 5.

The candidate palm print image is labeled with a candidate image label, and the candidate image label is configured for representing a palm print distribution of the candidate palm print image. The palm print distribution includes at least one of a major palm print line distribution or a minor palm print line distribution.

In an exemplary embodiment, the candidate image label corresponding to the candidate palm print image is determined based on a relative position relationship of the first data and the second data in the candidate palm print image.

Schematically, the first data is configured for indicating data corresponding to a major palm print line starting point, and the second data is configured for indicating data corresponding to a major palm print line ending point. When the candidate image label corresponding to the candidate palm print image is determined, a plurality of major palm print lines in the candidate palm print image are determined, and a major palm print line starting point and a major palm print line ending point that respectively correspond to the plurality of major palm print lines are respectively determined. Based on a relative position relationship between the major palm print line starting point and the major palm print line ending point respectively corresponding to each major palm print line, relative position information respectively corresponding to each major palm print line is determined. The candidate image label corresponding to the candidate palm print image is obtained in combination with the relative position information respectively corresponding to the plurality of major palm print lines.

In an exemplary embodiment, the candidate image label corresponding to the candidate palm print image is determined based on a relative position relationship of the plurality of minor palm print line positioning points in the candidate palm print image. Alternatively, the candidate image label corresponding to the candidate palm print image is determined based on the plurality of minor palm print line positioning points and the minor palm print line adjustment point.

The candidate image label labeled with the candidate palm print image is configured for representing an ID indicated by the candidate palm print image. For example, a candidate palm print image 1 is labeled with a candidate image label a1 based on a major palm print line distribution and a minor palm print line distribution. A candidate palm print image 2 is labeled with a candidate image label a2 based on the major palm print line distribution and the minor palm print line distribution.

Operation 640: Input the candidate palm print image and the palm print image to a palm print generation model obtained through pre-training, and perform constraint adjustment on the candidate palm print image using the palm print image, to obtain the sample palm print image.

In an exemplary embodiment, a feature is extracted from a candidate palm print image, to obtain a candidate feature representation corresponding to the candidate palm print image.

Schematically, after the candidate palm print image including the generated major palm print line and the generated minor palm print line is obtained, feature extraction is performed on the candidate palm print image, to obtain a candidate feature representation corresponding to the candidate palm print image. The candidate feature representation is configured for indicating image information of the generated candidate palm print image.

In some embodiments, the candidate feature representation corresponding to the candidate palm print image is obtained by performing a downsampling operation on the candidate palm print image. Alternatively, the candidate palm print image is processed by a common feature extraction model, and the candidate feature representation corresponding to the candidate palm print image is obtained.

In an exemplary embodiment, feature extraction is performed on the palm print image, to obtain an image feature representation respectively corresponding to at least one palm print image.

Schematically, in addition to performing feature extraction on the candidate palm print image, feature extraction is performed on at least one palm print image in the palm print image library. The at least one palm print image may be implemented as a plurality of palm print images in a palm print image library, or may be implemented as at least one palm print image randomly selected from a plurality of palm print images.

In some embodiments, the at least one palm print image is inputted to an encoder, to extract an image feature representation respectively corresponding to the at least one palm print image, where the encoder is formed by three layers of convolutional networks.

In an exemplary embodiment, based on a palm print distribution difference condition indicated by the label association relationship, constraint adjustment is performed on the candidate feature representation by using the at least one image feature representation, to obtain the sample palm print image.

Schematically, the candidate image label indicates a palm print distribution of the candidate palm print image, and the palm print image label indicates a palm print distribution of the palm print image. In some embodiments, the label association relationship between the candidate image label and the palm print image label is implemented as a label difference relationship. The label difference relationship is configured for indicating a palm print distribution difference between the generated candidate palm print image and the gathered palm print image.

In an exemplary embodiment, a palm print image label respectively corresponding to the at least one image feature representation is determined.

Schematically, after the image feature representation respectively corresponding to the at least one palm print image is extracted, the palm print image label respectively corresponding to the at least one image feature representation is determined.

In an exemplary embodiment, based on the palm print distribution difference condition indicated by the label association relationship, feature fusion is respectively performed on the at least one image feature representation and the candidate feature representation, to obtain an image fused feature representation respectively corresponding to the at least one image feature representation.

In some embodiments, the at least one image fused feature representation is upsampled, to obtain the sample palm print image respectively corresponding to the at least one image fused feature representation.

In some embodiments, after the fused feature representation is obtained, the size of the at least one image fused feature representation is restored through an upsampling process, to obtain a sample palm print image respectively corresponding to the at least one image fused feature representation.

Because the image fused feature representation is obtained after the candidate feature representation is adjusted according to the palm print feature representation corresponding to the gathered palm print image, authenticity of the palm print can be better reflected, and the sample palm print image obtained based on the fused feature representation can also better reflect the authenticity of the palm print.

In an exemplary embodiment, the foregoing feature fusion process of obtaining the image fused feature representation is implemented by using a generator (or referred to as a palm print generation model). To be specific, after the trained generator is obtained, the image feature representation corresponding to the palm print image is fused with the candidate feature representation corresponding to the candidate palm print image by using the generator, and the image fused feature representation is upsampled to obtain the sample palm print image.

The sample palm print image is configured for training a palm print recognition model. The palm print recognition model is configured for performing palm print recognition.

The foregoing is merely an illustrative example. This is not limited in this embodiment of this application.

In conclusion, a palm print generation model is obtained through pre-training by using a palm print image label of a pre-gathered palm print image and a candidate image label, and a sample palm print image corresponding to the candidate palm print image is generated by using the palm print generation model, so that a palm print distribution in the sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

In this embodiment of this application, a method for generating a candidate palm print image is improved, and it is provided that the candidate palm print image and a palm print image are inputted to a palm print generation model obtained through pre-training, and constraint adjustment is performed on the candidate palm print image by using the palm print image, to obtain a sample palm print image. In this process, in addition to the palm print generation model obtained through training, a more targeted adjustment process can be performed on the candidate palm print image by using the palm print image, thereby synthesizing the palm print generation model and the palm print image, and improving generation authenticity of the sample palm print image.

In an exemplary embodiment, in addition to obtaining the palm print generation model through training by using a loss value determined between the candidate generation model and the palm print image and generating the sample palm print image, a feature similarity calculation process is performed by using the generated sample palm print image and the palm print image, to constrain identity consistency between the sample palm print image and at least one palm print image by using a feature similarity calculation result. Schematically, as shown in FIG. 8, it may further be implemented as the following operations 810 to 830.

Operation 810: Obtain a target feature extraction model.

The target feature extraction model is a feature extraction model obtained through pre-training by using a plurality of palm print images in a palm print image library. To be specific, a training process of the target feature extraction model is associated with at least one palm print image.

Operation 820: Perform feature extraction on a sample palm print image in training and at least one palm print image using the target feature extraction model, to obtain a first feature representation corresponding to the sample palm print image in training and a second feature representation corresponding to the at least one palm print image.

Schematically, after the sample palm print image in training and the at least one palm print image are obtained, feature extraction is performed on the sample palm print image in training by using the target feature extraction model, to obtain the first feature representation corresponding to the sample palm print image in training. In addition, feature extraction is further performed on the at least one palm print image by using the target feature extraction model, to obtain the second feature representation corresponding to the at least one palm print image.

Operation 830: Perform a label constraint on the sample palm print image based on a feature difference between the first feature representation and the at least one second feature representation.

The label constraint is configured for constraining identity consistency between the sample palm print image and the at least one palm print image. To be specific, the sample palm print image and the at least one palm print image are restricted to indicate identities that are the same as possible.

Schematically, after the first feature representation representing the sample palm print image in training and the second feature representation representing the palm print image are obtained, a cosine similarity between the first feature representation and the at least one second feature representation is calculated, to obtain at least one feature similarity.

In some embodiments, a label constraint is performed on the sample palm print image based on the at least one feature similarity.

In some embodiments, an identity constraint feature respectively corresponding to the at least one second feature representation is determined based on the at least one feature similarity, and a label constraint is performed on the sample palm print image by using the identity constraint feature.

Schematically, a cosine similarity sim between any second feature representation in the at least one second feature representation and the first feature representation is calculated. Then (1-sim) is used as an identity constraint feature, to constrain identity consistency between the second feature representation and the first feature representation.

Because the first feature representation indicates the sample palm print image in training, identity information is determined for the sample palm print image in training based on the candidate image label labeled with the corresponding candidate palm print image. When identity consistency between the second feature representation and the first feature representation is constrained, an identity constraint is performed by using the first feature representation as a reference.

In some embodiments, a feature distance between a second feature representation having a feature similarity greater than a preset similarity threshold and the first feature representation is reduced, and a feature distance between a second feature representation having a feature similarity less than the preset similarity threshold and the first feature representation is increased, thereby performing a label constraint on the sample palm print image corresponding to the first feature representation.

In some embodiments, the foregoing label constraint method is applied to a training process of a palm print recognition model, so that an identity association relationship is established between a generated sample palm print image and a stored palm print image, thereby facilitating the palm print recognition model to learn more abundant identity information related to the identity association relationship, and further facilitating, when a target palm print recognition model is applied, determining a palm print image corresponding to a to-be-recognized object in a plurality of palm print images stored in a palm print image library, thereby improving recognition accuracy of the target palm print recognition model.

The foregoing is merely an illustrative example. This is not limited in this embodiment of this application.

In conclusion, a palm print generation model is obtained through pre-training by using a palm print image label of a pre-gathered palm print image and a candidate image label, and a sample palm print image corresponding to the candidate palm print image is generated by using the palm print generation model, so that a palm print distribution in the sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

In this embodiment of this application, content of performing a label constraint on the sample palm print image by using the target feature extraction model is described. Because the target feature extraction model is a feature extraction model obtained through pre-training by using a plurality of palm print images, the model can pay more intense attention to a palm print generation feature indicated by a palm print image, thereby improving a label constraint capability of a sample palm print image, facilitating establishing an identity association relationship between the generated sample palm print image and a stored palm print image, ensuring authenticity of a sample generation image, and avoiding impact on recognition accuracy of the palm print recognition model by improper training of the palm print recognition model by using an unrealistic sample generation image.

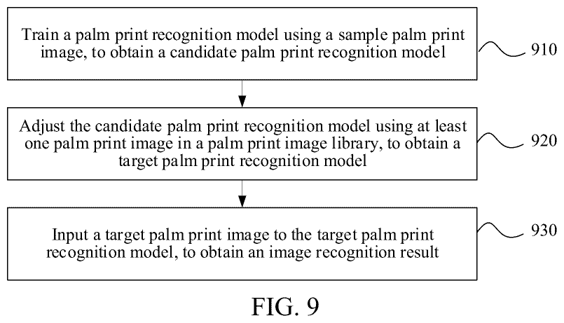

In an exemplary embodiment, after the sample palm print image is obtained, the palm print recognition model is trained by using the sample palm print image, and a trained target palm print recognition model is obtained. Schematically, as shown in FIG. 9, after operation 240 shown in FIG. 2, the method may further include the following operations 910 to 930.

Operation 910: Train a palm print recognition model using a sample palm print image, to obtain a candidate palm print recognition model.

The palm print recognition model is a pre-obtained to-be-trained model, and is configured for performing a palm print recognition process, to determine palm print information corresponding to a palm print image. The palm print information includes at least one of palm print distribution information or palm print identity information. The palm print distribution information is configured for indicating distribution of a major palm print line and/or a minor palm print line in the palm print image. The palm print identity information is configured for indicating object information corresponding to the palm print image.

Schematically, after a sample palm print image is obtained, the palm print recognition model is trained by using the generated sample palm print image, to obtain the candidate palm print recognition model.

In some embodiments, the candidate palm print recognition model is obtained in response to the palm print recognition model being trained to reach a training condition. For example, when the quantity of trainings of training the palm print recognition model by the generated sample palm print image reaches a preset training quantity, it is considered that the training condition is reached, to obtain the candidate palm print recognition model. Alternatively, when a training degree for training the palm print recognition model by using the generated sample palm print image converges (for example, a loss value for training does not change), it is considered that the training condition is reached, to obtain the candidate palm print recognition model.

Operation 920: Adjust the candidate palm print recognition model using at least one palm print image in a palm print image library, to obtain a target palm print recognition model.

The target palm print recognition model is configured for performing palm print recognition.

Schematically, after a candidate palm print recognition model is obtained, the candidate palm print recognition model is adjusted by using at least one palm print image gathered from the palm print image library, to improve recognition accuracy of the candidate palm print recognition model on a true palm print, thereby obtaining a target palm print recognition model with higher recognition accuracy.

Operation 930: Input a target palm print image to the target palm print recognition model, to obtain an image recognition result.

The target palm print image is configured for indicating a palm print image on which palm print recognition is to be performed. Schematically, after a target palm print recognition model is obtained, a to-be-recognized target palm print image is inputted to the target palm print recognition model, to obtain an image recognition result. The image recognition result is implemented as palm print information corresponding to the target palm print image, including at least one of palm print distribution information or palm print identity information.

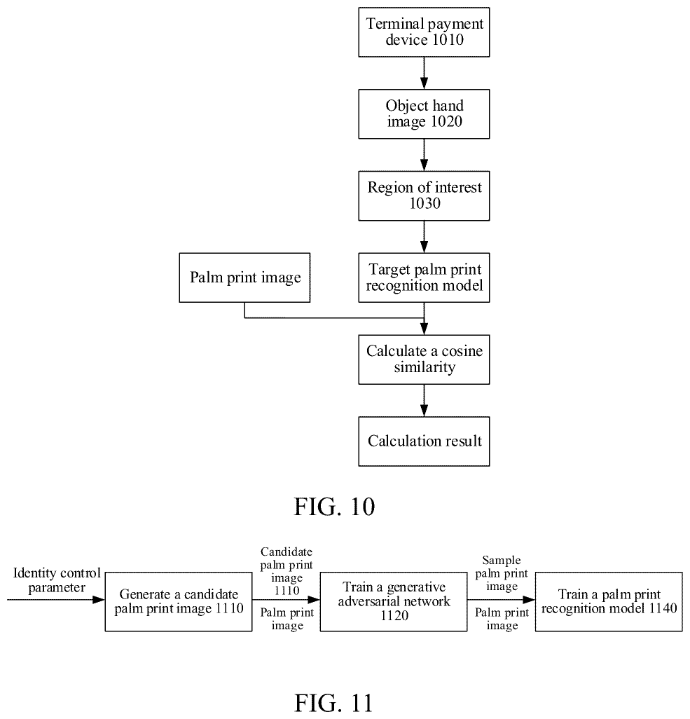

In some embodiments, an example is used in which the target palm print recognition model is applied to recognize a hand to implement a payment process. As shown in FIG. 10, descriptions are provided by using an example in which a target palm print image is from an image gathered by a terminal payment device 1010. An object hand image 1020 gathered by the terminal payment device 1010 is used as a to-be-recognized target palm print image. When the object hand image 1020 is recognized, to precisely recognize a region, region extraction is first performed on the object hand image 1020, to obtain a region of interest 1030 in the object hand image 1020. A 5 cm*5 cm region in the object palm print image 1020 is cropped to serve as the region of interest 1030. The region of interest 1030 includes a major palm print line and a minor palm print line, and is an object palm print image region representing palm print content in the object hand image 1020.

A feature is extracted from the region of interest 1030 by using the target palm print recognition model, to obtain a feature representation of interest corresponding to the region of interest 1030. In addition, feature extraction is performed on a plurality of pre-gathered palm print images, to obtain palm print feature representations respectively corresponding to the plurality of palm print images.

After the feature representation of interest and the palm print feature representations respectively corresponding to the plurality of palm print images are obtained, cosine similarities respectively corresponding to the feature representation of interest and the plurality of palm print feature representations are calculated, to obtain a plurality of cosine similarity results.

In some embodiments, a maximum cosine similarity result is selected from the plurality of cosine similarity results, a palm print image corresponding to the maximum cosine similarity result is determined, and object information corresponding to the palm print image is used as a calculation result corresponding to the object palm print image 1020. For example, it is determined that the object palm print image 1020 is an object having an ID of 36 in the plurality of palm print images.

The foregoing is merely an illustrative example. This is not limited in this embodiment of this application.

In conclusion, because a candidate palm print image is an image obtained based on a major palm print line distribution pattern and a minor palm print line distribution pattern, the candidate palm print image has characteristics of large quantity and diversity. In addition, to make the candidate palm print image more consistent with an image of a real palm print, constraint adjustment is performed on the generated candidate palm print image by using a pre-gathered palm print image, so that a palm print distribution in the adjusted sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

In this embodiment of this application, a training process of training the palm print recognition model by using the sample palm print image is described. First, the palm print recognition model is trained by using the generated sample palm print image, to obtain the candidate palm print recognition model. Then, the candidate palm print recognition model is adjusted by using the gathered palm print image, to improve recognition authenticity of the candidate palm print recognition model, to obtain a target palm print recognition model with higher recognition accuracy, so that a more accurate image recognition result is obtained when the target palm print recognition model is configured for recognizing the to-be-recognized target palm print image, thereby improving the application scope of the target palm print recognition model.

In an exemplary embodiment, the foregoing method for generating a sample palm print image is referred to as “an identity-controllable palm print generation method.” An overall procedure of the method is shown in FIG. 11.

(1) A candidate palm print image 1110 is generated.

Schematically, based on observation on a large amount of real palm print data, a pattern of palm print texture is implemented as follows. Generally, there are two to five major palm print lines. For a left hand, the major palm print lines usually start at an upper left corner and end at a lower right corner. For a right hand, the major palm print lines are opposite. There are more minor palm print lines, which are shallower and shorter than the major lines.

In some embodiments, the palm print is parameterized by using a second-order Bezier curve, to represent a major palm print line and a minor palm print line. Three parameter points (a starting point, an ending point, and an adjustment point) are set in a 2D plane to complete unique determination of one Bezier curve, to simulate the texture of the palm print.

In some embodiments, the foregoing process of performing parameterization determining on the palm print texture is used as an identity control parameter, so as to generate a Bezier identity control curve.

In an exemplary embodiment, a first region and a second region that correspond to a direction of the major palm print line are determined according to a preset major palm print line distribution pattern.

Schematically, a palm print of a palm is used as an example for description, and a distribution of a major palm print line in the palm print of the palm has a particular pattern. FIG. 3 schematically shows distribution of a palm print. A major palm print line 320 is presented generally in a presentation form in which an upper left corner is a first major line positioning point, and a lower right corner is a second major line positioning point. Alternatively, a lower right corner is considered as a first major line positioning point of the major palm print line 320, and an upper left corner is considered as a second major line positioning point of the major palm print line 320. In some embodiments, the major palm print line is analyzed in a form of using an upper left corner as the first major line positioning point, and a lower right corner as the second major line positioning point.

In an exemplary embodiment, a first vertex and a second vertex that are in a diagonal relationship are determined in a preset palm print generation region. A first region is determined in the palm print generation region by using the first vertex as a center and a first preset length as a radius.

Schematically, after the first vertex is determined, the first region determined based on the first vertex is a sector region. A center of the sector region is the first vertex, and a radius of the sector region is the first preset length. Alternatively, the sector region is considered as a ¼ circular region, a midpoint of the circular region is the first vertex, and a radius of the circular region is the first preset length.

In some embodiments, the first preset length may be a preset fixed value, or may be a value determined based on the palm print generation region.

Schematically, when the palm print generation region is a square region having a unit length, the center is the third vertex. For the first major line positioning point, coordinates of the first major line positioning point are defined as follows:

$${x}^{2} + {( y - 1 )}^{2} \leq \frac{1}{4} , x ∈ [ 0 , \frac{1}{2} ] , y ∈ [ \frac{1}{2} , 1 ]$$

where x is configured for indicating a horizontal axis coordinate, and y is configured for indicating a vertical axis coordinate.

In an exemplary embodiment, a second region is determined in the palm print generation region by using the second vertex as a center and a second preset length as a radius.

In some embodiments, the process of determining the second region based on the second vertex is similar to the process of determining the first region based on the first vertex. Schematically, the second preset length and the first preset length may have the same or different length values.

Schematically, when the palm print generation region is a square region having a unit length, as shown in FIG. 9, the center is the third vertex. For the first major line positioning point, coordinates of the first major line positioning point are defined as follows:

$${( x - 1 )}^{2} + {y}^{2} \leq \frac{1}{4} , x ∈ [ \frac{1}{2} , 1 ] , y ∈ [ 0 , \frac{1}{2} ]$$

where x is configured for indicating a horizontal axis coordinate, and y is configured for indicating a vertical axis coordinate.

Alternatively, when the second preset length and the first preset length have different length values, a region shape of the second region formed by using the second vertex as the center and the second preset length as the radius is different from a region shape of the first region formed by using the first vertex as the center and the first preset length as the radius. For example, when the palm print generation region is a square region, if the length value of the second preset length is larger and the length value of the first preset length is smaller, the second region corresponding to the second preset length is larger than the first region corresponding to the first preset length.

The foregoing is merely an illustrative example. This is not limited in this embodiment of this application.

In an exemplary embodiment, after a first region is determined, first data corresponding to the first major line positioning point is determined in the first region in a random selection mode. After a second region is determined, second data corresponding to the first major line positioning point is determined in the second region in a random selection mode.

In some embodiments, a third region is determined based on a position relationship between the first major line positioning point and the second major line positioning point according to a major palm print line radian pattern.

Schematically, the major palm print line radian pattern is configured for indicating a bending condition of the major palm print line. For example, a radian of the major palm print line in the palm print is small. A bending degree of the major palm print line in the palm print is smooth.

In some embodiments, the third region for generating a major line adjustment point is determined based on the position relationship between the first major line positioning point and the second major line positioning point.

In an exemplary embodiment, the first major line positioning point and the second major line positioning point are connected, to obtain a target line segment.

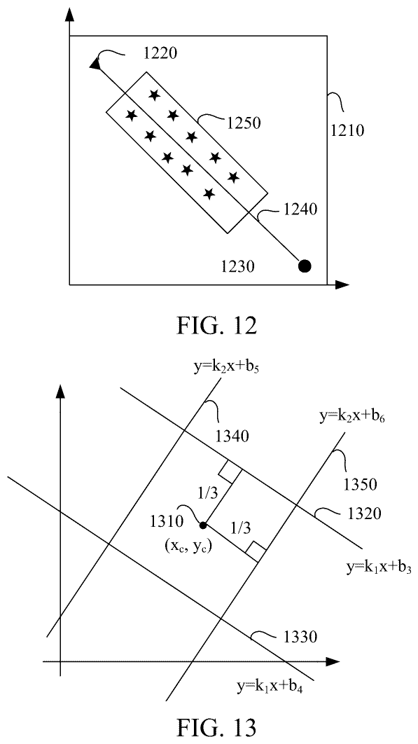

Schematically, as shown in FIG. 12, in a palm print generation region 1210, a first major line positioning point 1220 (indicated by an “inverted triangle” symbol) and a second major line positioning point 1230 (indicated by a “circle” symbol) are determined, and a target line segment 1240 is obtained after the first major line positioning point 1220 and the second major line positioning point 1230 are connected.

In some embodiments, a rectangular region having a preset side length is used as the third region by using a line segment midpoint of the target line segment as a center.

Schematically, the preset side length not only includes a preset fixed value, but also includes a value determined based on the palm print generation region.

For example, the preset side length is a preset fixed value. When the third region is determined based on the line segment midpoint, the rectangular region determined in the palm print generation region is used as the third region by using the line segment midpoint as the center and the preset fixed value as the side length. For example, the preset fixed value includes: a length a of a rectangle and a width b of the rectangle. The line segment midpoint is used as a center, the length a of the rectangle is used as a length of the third region, and the width b of the rectangle is used as a width of the third region, so as to obtain the third region.

Alternatively, the preset side length is a value determined based on the palm print generation region (for example, half of the side length in the palm print generation region is used as the side length; alternatively, half of the target line segment in the palm print generation region is used as the side length). When the first region is determined based on the line segment midpoint, the line segment midpoint is used as a center, and a value determined based on the palm print generation region is used as the side length, to determine the third region in the palm print generation region.

For example, as shown in FIG. 12, after the target line segment 1240 is obtained, a line segment midpoint of the target line segment 1240 is used as a center, and a preset fixed value is used as a side length, to obtain a third region 1250.

In an exemplary embodiment, it is assumed that midpoint coordinates of the target line segment connecting the first major line positioning point and the second major line positioning point are (x_{c}, y_{c}). The process of determining the third region by using the midpoint coordinates (x_{c}, y_{c}) as the center and using the target line segment as a determining reference is shown below.

Schematically, the length of the palm print generation region is a unit length 1, and a to-be-obtained third region is a square region. A side length of the square region is preset to ⅔. Therefore, the third region is a square region that uses the midpoint coordinates (x_{c}, y_{c}) as the center, is parallel to the target line segment, and has a side length of ⅔.

In some embodiments, the third region is obtained through a method for determining a linear equation. The linear equation is uniquely determined by the major line positioning point and the second major line positioning point. Schematically, a straight line in which the target line segment connecting the first major line positioning point and the second major line positioning point is located is defined as a straight line A. The straight line A is y=k₁x+b₁. Similarly, a straight line B that passes through the midpoint coordinates (x_{c}, y_{c}) and is perpendicular to the straight line A is defined as y=k₂x+b₂,
where k₁ is configured for indicating a slope corresponding to the straight line A, b₁ is configured for indicating an intercept corresponding to the straight line A, k₂ is configured for indicating a slope corresponding to the straight line B, and b₂ is configured for indicating an intercept corresponding to the straight line B. A relationship of k₁, b₁, k₂, and b₂ is shown as follows.

$$\{ \begin{matrix}{k}_{1} {k}_{2} = - 1 \\ {k}_{2} {x}_{c} + {b}_{2} = {y}_{c}\end{matrix}$$

To be specific, the straight line B may be uniquely determined according to the straight line A and the midpoint coordinates (x_{c}, y_{c}).

In some embodiments, as shown in FIG. 13, based on midpoint coordinates 1310 (x_{c}, y_{c}) and the preset side length ⅔ of the third region, a straight line A₁ 1320 and a straight line A₂ 1330 that are parallel to the straight line A and distant from the straight line A by a vertical distance of ⅓ are determined respectively. A straight line B₁ 1340 and a straight line B₂ 13350 that are parallel to the straight line B and distant from the straight line B by a vertical distance of ⅓ are determined.

An equation of the straight line A₁ 1320 is: y=k₁x+b₃. An equation of the straight line A₂ 1330 is: y=k₁x+b₄. An equation of the straight line B₁ 1340 is: y=k₂x+b₅. An equation of the straight line B₂ 1350 is: y=k₂x+b₆.

The foregoing is merely an illustrative example. This is not limited in this embodiment of this application.

Schematically, as shown in FIG. 13, according to the foregoing four straight lines: the straight line A₁ 1320, the straight line A₂ 1330, the straight line B₁ 1340, and the straight line B₂ 1350, values of the four straight lines may be uniquely determined, a square region formed by the four straight lines is determined, and the square region is used as the third region.

In an exemplary embodiment, adjustment point data is generated in the third region.

In some embodiments, after the third region is determined, the adjustment point data for adjusting the radian of the major line is generated from the third region. Schematically, a coordinate value range of the adjustment point data may be defined in the following form:

$$\{ \begin{matrix}{k}_{1} x + {b}_{3} \leq y \\ {k}_{1} x + {b}_{4} \geq y \\ {k}_{2} x + {b}_{5} \leq y \\ {k}_{2} x + {b}_{6} \geq y\end{matrix}$$

where k₁ is configured for indicating slopes corresponding to the straight line A₁ 1320 and the straight line A₂ 1330, b₃ is configured for indicating an intercept corresponding to the straight line A₁₃ 120, b₄ is configured for indicating an intercept corresponding to the straight line A₂ 1330, k₂ is configured for indicating slopes corresponding to the straight line B₁₃ 140 and the straight line B₂ 1350, b₅ is configured for indicating an intercept corresponding to the straight line B₁₃ 140, and b₆ is configured for indicating an intercept corresponding to the straight line B₂ 1350.

In some embodiments, the major palm print line is generated based on the first data, the second data, and the adjustment point data.

The major palm print line is a curve sequentially connecting the first major line positioning point, the major line adjustment point, and the second major line positioning point.

Schematically, the major palm print line is a curve obtained by sequentially connecting the first major line positioning point, the major line adjustment point, and the second major line positioning point according to an order. Coordinate positions of the first major line positioning point and the second major line positioning point are determined. The major line adjustment point may adjust a radian of a line segment formed between the first major line positioning point and the second major line positioning point, to obtain different major palm print lines. The position of the major line adjustment point also has a close relationship with the formation of the major palm print line.

In some embodiments, a candidate palm print image including a major palm print line and a minor palm print line is generated.

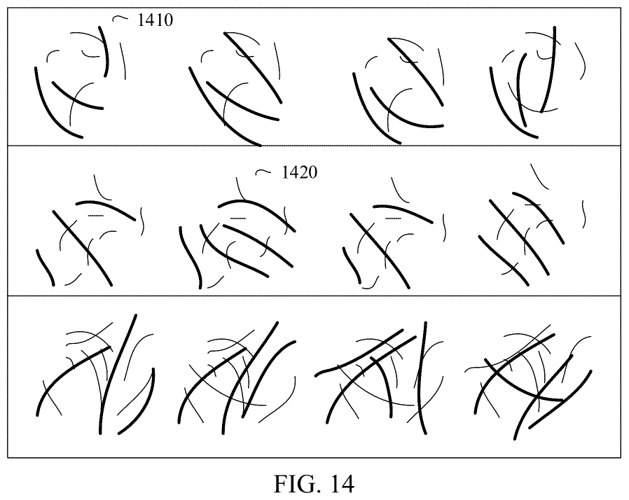

Schematically, as shown in FIG. 14, a plurality of candidate palm print images are generated in a second-order Bezier curve mode, and the candidate palm print images may alternatively be referred to as Bezier curve images. For example, a candidate palm print image 1410 includes three major palm print lines and five minor palm print lines. A candidate palm print image 1420 includes four major palm print lines, seven minor palm print lines, and the like.

(2) The candidate palm print image 1110 and the palm print image are inputted to a generative adversarial network 1120 for training, and a sample palm print image is generated.

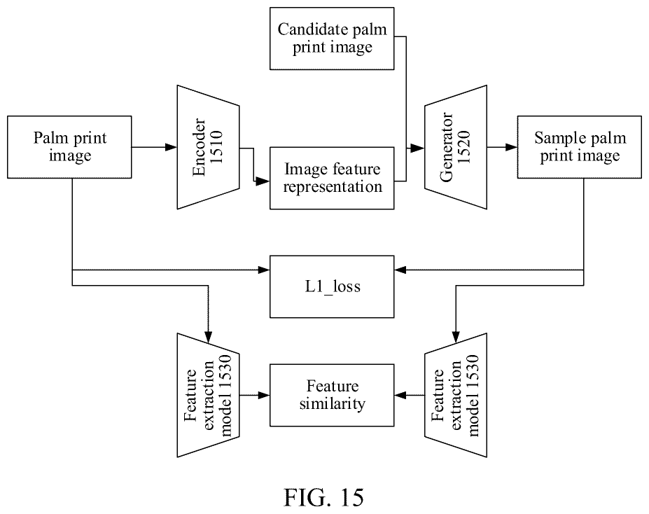

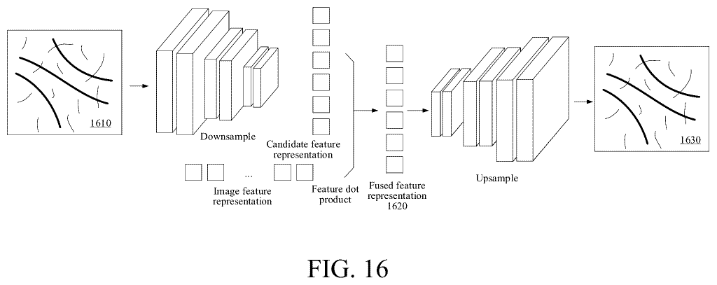

Schematically, after the generated candidate palm print image and the gathered palm print image are obtained, the candidate palm print image and the palm print image are inputted to a generative adversarial network shown in FIG. 15.

(1) The palm print image is inputted to an encoder (f_encoder) 1510, and an image feature representation feature_encoder corresponding to the palm print image is extracted. The encoder includes three layers of convolutional networks, to obtain the image feature representation corresponding to the palm print image, where a feature dimension is 64.

(2) The extracted image feature representation is used as a condition probability, and is inputted to a generator (f_decoder) 1520 together with a candidate palm print image (Bezier curve image bezier_img). A specific network structure of the generator 1520 is shown in FIG. 16.

As shown in FIG. 16, a model structure of the generator mainly includes three layers of downsampling network structures and three layers of upsampling network structures.

A candidate palm print image 1610 is first downsampled by using three convolution layers, to extract a candidate feature representation (which may alternatively be referred to as a Bezier feature representation) corresponding to the candidate palm print image 1610. A feature dimension is consistent with that of the image feature representation extracted in (1), and the feature dimension is 64.

In some embodiments, a bitwise dot product operation is performed on the candidate feature representation and the image feature representation, to obtain a fused feature representation 1620. Based on that both the feature dimension of the image feature representation and the feature dimension of the candidate feature representation are 64, a feature dimension of the fused feature representation 1620 is also 64.

The main function of this operation is to constrain the candidate feature representation by using the image feature representation corresponding to the gathered palm print image, so that the generator can learn muscle texture information of the palm print image. A sample palm print image 1630 with a muscle and a palm print line is obtained after the fused feature representation 1620 is upsampled by using three layers of deconvolution networks.

(3) The generated sample palm print image (simulated palm print image) and the palm print image are mixed and inputted to a palm print recognition model for training.

Schematically, as shown in FIG. 15, after the sample palm print image is obtained, a loss value L1_loss between the generated sample palm print image and the palm print image is calculated by using the following formula:

L1_loss=|(sample_img,gather_img)|
where sample_img is configured for indicating the generated sample palm print image, and gather_img is configured for indicating the gathered palm print image.

Schematically, the sample palm print image is generated by using the generator 1520. In a training stage of the palm print generation model, the generator 1520 is trained by using the loss value L1_loss until a training condition is satisfied.

(4) Feature extraction is separately performed on the gathered palm print image and the generated sample palm print image by using a feature extraction model 1530 obtained through training of the palm print image, to obtain a palm print feature representation feature_gt corresponding to the palm print image and a sample feature representation feature_generated corresponding to the generated sample palm print image, a cosine similarity sim between the palm print feature representation and the sample feature representation is calculated, and (1-sim) is used as an identity constraint feature to constrain identity consistency between the sample palm print image and the palm print image.

Schematically, in an application stage of the palm print generation model, the generated candidate palm print image is inputted to the generator 1320, to obtain the generated sample palm print image. In some embodiments, the finally generated sample palm print image is implemented as the image shown in FIG. 14, and not only includes palm print texture information, but also includes muscle texture information.

(3) A palm print recognition model 1140 is trained.

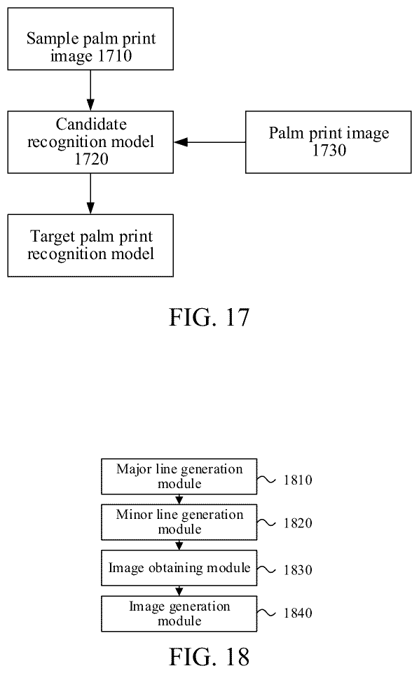

In an exemplary embodiment, as shown in FIG. 17, model pretraining is performed on the palm print recognition model by using a sample palm print image 1710.

In some embodiments, a model structure of the palm print recognition model is implemented as a mobile face detection network (mobilefacenet), and a candidate recognition model 1720 is obtained based on model pretraining.

Then, model fine tuning is performed on the candidate recognition model 1720 by using a pre-gathered palm print image 1730, to obtain a target palm print recognition model.

The foregoing is merely an illustrative example. This is not limited in this embodiment of this application.

As shown in the following table, recognition data of the target palm print recognition model and recognition data obtained by using another palm print recognition technology are included.

TABLE 1
Public dataset

| | | | | |
|---|---|---|---|---|
| Method | far@1e−3 | far@1e−4 | far@1e−5 | far@1e−6 |
| ArcFace | TPR = 92.92 | TPR = 85.68 | TPR = 78.12 | TPR = 70.49 |
| ArcFac + Ours | TPR = 97.63 | TPR = 95.81 | TPR = 93.76 | TPR = 89.24 |

Table 1 provides a comparison between recognition effects of the palm print sample generation method provided in this embodiment of this application and a conventional method in the field of palm print recognition on a public dataset. The evaluation index is a true positive rate (TPR).

TABLE 2
Service dataset

| | | | | |
|---|---|---|---|---|
| Method | far@1e−3 | far@1e−4 | far@1e−5 | far@1e−6 |
| ArcFace | TPR = 99.11 | TPR = 97.70 | TPR = 95.50 | TPR = 92.51 |
| ArcFace + | TPR = 99.85 | TPR = 98.96 | TPR = 97.15 | TPR = 94.97 |
| Ours | | | | |

Table 2 provides a comparison between recognition effects of the palm print sample generation method provided in this embodiment of this application and a conventional method in the field of palm print recognition on a service dataset, and the evaluation index is also the TPR.

A baseline used therein is an iris soft recognition technology (ArcFace), and a backbone network is a mobile phone network (MobileFaceNet). It can be seen that in both the public dataset and the service dataset, the target palm print recognition model trained by using the palm print sample generation method provided in this embodiment of this application has a recognition effect better than a recognition result obtained by using ArcFace.

In conclusion, because a candidate palm print image is an image obtained based on a major palm print line distribution pattern and a minor palm print line distribution pattern, the candidate palm print image has characteristics of large quantity and diversity. In addition, to make the candidate palm print image more consistent with an image of a real palm print, constraint adjustment is performed on the generated candidate palm print image by using a pre-gathered palm print image, so that a palm print distribution in the adjusted sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

FIG. 18 is a structural block diagram of a method for generating a sample palm print image according to an exemplary embodiment of this application. As shown in FIG. 18, the apparatus includes the following parts:
a major line generation module 1810, configured to generate at least one major palm print line according to a preset major palm print line distribution pattern;
a minor line generation module 1820, configured to determine a palm print distribution region in which the at least one major palm print line is located, and generate at least one minor palm print line in the palm print distribution region based on a preset minor palm print line distribution pattern;
an image obtaining module 1830, configured to obtain a candidate palm print image based on the at least one major palm print line and the at least one minor palm print line, where the candidate palm print image is labeled with a candidate image label, the candidate image label is configured for representing a palm print distribution of the candidate palm print image, and the palm print distribution includes at least one of a major palm print line distribution or a minor palm print line distribution; and
an image generation module 1840, configured to input the candidate palm print image to a palm print generation model obtained through pre-training, to obtain a sample palm print image, where the palm print generation model is a model obtained through pre-training by using a palm print image label of a pre-gathered palm print image and the candidate image label, the palm print image label is configured for indicating a palm print distribution of the palm print image, the sample palm print image is configured for training a palm print recognition model, and the palm print recognition model is configured for performing palm print recognition.

In an exemplary embodiment, the palm print generation model is a model obtained after performing model training on a candidate generation model.

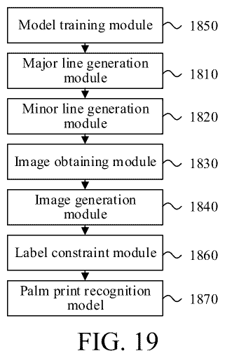

As shown in FIG. 19, the apparatus further includes:
a model training module 1850, configured to: obtain a palm print image library, where the palm print image library pre-stores a plurality of gathered palm print images, and the plurality of palm print images are respectively labeled with palm print image labels; perform feature extraction on the palm print image, to obtain an image feature representation corresponding to the palm print image; perform feature extraction on the candidate palm print image, to obtain a candidate feature representation corresponding to the candidate palm print image; fuse the candidate feature representation and the image feature representation using a to-be-trained candidate generation model and them perform upsampling, to obtain a candidate sample palm print image; and train the candidate generation model by using the candidate sample palm print image, to obtain the palm print generation model, where the palm print generation model is configured for generating the sample palm print image.

In an exemplary embodiment, the model training module 1850 is further configured to: determine a candidate palm print image corresponding to the candidate sample palm print image, and use a candidate image label corresponding to the candidate palm print image as a sample image label of the candidate sample palm print image; obtain, based on a distribution difference between a palm print distribution indicated by the sample image label and a palm print distribution indicated by the palm print image label, a loss value corresponding to the candidate sample palm print image; and train the candidate generation model by using the loss value, to obtain the palm print generation model.

In an exemplary embodiment, the model training module 1850 is further configured to: perform feature fusion processing on the candidate feature representation and the image feature representation by using the candidate generation model, to obtain a fused feature representation, where the fused feature representation is configured for representing a feature representation obtained after constraint adjustment is performed on the candidate feature representation by using at least one image feature representation; and upsample the fused feature representation, to obtain the candidate sample palm print image.

In an exemplary embodiment, the apparatus further includes:
a label constraint module 1860, configured to: obtain a target feature extraction model, where the target feature extraction model is a feature extraction model obtained through pre-training by using a plurality of palm print images in the palm print image library; separately perform feature extraction on the sample palm print image in training and the at least one palm print image using the target feature extraction model, to obtain a first feature representation corresponding to the sample palm print image and a second feature representation corresponding to the at least one palm print image; and perform a label constraint on the sample palm print image based on a feature difference between the first feature representation and the at least one second feature representation, where the label constraint is configured for constraining identity consistency between the sample palm print image and the at least one palm print image.

In an exemplary embodiment, the label constraint module 1860 is further configured to: calculate a cosine similarity between the first feature representation and the at least one second feature representation, to obtain at least one feature similarity; and perform a label constraint on the sample palm print image based on the at least one feature similarity.

In an exemplary embodiment, the apparatus further includes:
a palm print recognition model 1870, configured to: train the palm print recognition model by using the sample palm print image, to obtain a candidate palm print recognition model; and adjust the candidate palm print recognition model by using the at least one palm print image in the palm print image library, to obtain a target palm print recognition model, where the target palm print recognition model is configured for performing palm print recognition.

In an exemplary embodiment, the image generation module 1840 is further configured to input the candidate palm print image and the palm print image to a palm print generation model obtained through pre-training, and perform constraint adjustment on the candidate palm print image by using the palm print image, to obtain the sample palm print image.

In an exemplary embodiment, the major line generation module 1810 is further configured to: generate positioning point data according to the preset major palm print line distribution pattern, where the positioning point data includes first data corresponding to a first major line positioning point and second data corresponding to a second major line positioning point; generate adjustment point data according to a major palm print line radian pattern, where a major line adjustment point corresponding to the adjustment point data is configured for controlling a radian of a major line formed by the first major line positioning point and the second major line positioning point; and generate the at least one major palm print line based on the first data, the second data, and the adjustment point data, where the major palm print line is a curve sequentially connecting the first major line positioning point, the major line adjustment point, and the second major line positioning point.

In an exemplary embodiment, the minor line generation module 1820 is further configured to: determine a palm print distribution region in which the at least one major palm print line is located, and determine a plurality of minor palm print line positioning points in the palm print distribution region based on the preset minor palm print line distribution pattern; and generate the at least one minor palm print line in the palm print distribution region based on the plurality of minor palm print line positioning points.

In conclusion, a palm print generation model is obtained through pre-training by using a palm print image label of a pre-gathered palm print image and a candidate image label, and a sample palm print image corresponding to the candidate palm print image is generated by using the palm print generation model, so that a palm print distribution in the sample palm print image is more accurate, which not only breaks through a limitation of a small quantity of palm prints, but also improves reality of the sample palm print image, thereby facilitating improving robustness of a palm print recognition model, and improving palm print recognition accuracy of the palm print recognition model.

The apparatus for generating a sample palm print image provided in the foregoing embodiment is only illustrated with an example of division of the foregoing function modules. In practical application, the foregoing functions may be allocated to and completed by different function modules according to requirements. To be specific, an internal structure of a device is divided into different function modules, so as to complete all or part of the functions described above. In addition, the apparatus for generating a sample palm print image provided in the foregoing embodiment belongs to the same conception as the embodiment of the method for generating a sample palm print image. For a specific implementation process thereof, refer to the method embodiment. Details are not described herein again.

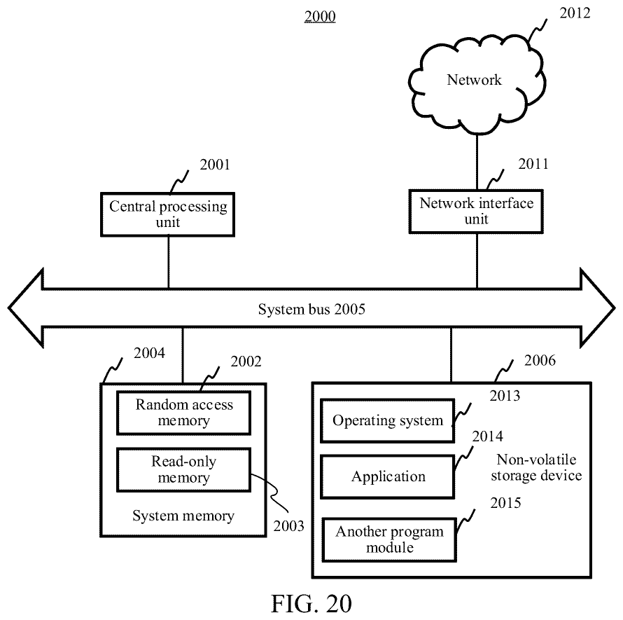

FIG. 20 shows a schematic structural diagram of a server according to an exemplary embodiment of this application. The server 2000 includes a central processing unit (CPU) 2001, a system memory 2004 including a random access memory (RAM) 2002 and a read-only memory (ROM) 2003, and a system bus 2005 connecting the system memory 2004 and the CPU 2001. The server 2000 further includes a non-volatile storage device 2006 configured to store an operating system 2013, an application 2014, and another program module 2015.

The non-volatile storage device 2006 is connected to the CPU 2001 by using a non-volatile storage controller (not shown) connected to the system bus 2005. The non-volatile storage device 2006 and a computer-readable medium associated therewith provide non-volatile storage to the server 2000. To be specific, the non-volatile storage device 2006 may include a computer-readable medium (not shown) such as a hard disk or a compact disc read only memory (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable read only memory (EPROM), an electrically erasable programmable read only memory (EEPROM), a flash memory or another solid-state storage technology, a CD-ROM, a digital versatile disc (DVD) or another optical memory, a tape cartridge, a magnetic tape, a magnetic disk memory, or another magnetic storage device. Certainly, a person skilled in art can know that the computer storage medium is not limited to the foregoing several types. The system memory 2004 and the non-volatile storage device 2006 may be collectively referred to as a memory.

According to embodiments of this application, the server 2000 may further be connected, via a network such as the Internet, to a remote computer on the network and run. To be specific, the server 2000 may be connected to a network 2012 by using a network interface unit 2011 connected to the system bus 2005, or may be connected to another type of network or a remote computer system (not shown) by using the network interface unit 2011.

The memory further includes one or more programs. The one or more programs are stored in the memory and configured to be executed by the CPU.

An embodiment of this application further provides a computer device. The computer device includes a processor and a memory. The memory has at least one instruction, at least one program, a code set, or an instruction set stored therein. The at least one instruction, the at least one program, the code set, or the instruction set is loaded and executed by the processor to implement the method for generating a sample palm print image provided in the foregoing method embodiments.

An embodiment of this application further provides a computer-readable storage medium. The computer-readable storage medium has at least one instruction, at least one program, a code set, or an instruction set stored therein. The at least one instruction, the at least one program, the code set, or the instruction set is loaded and executed by a processor to implement the method for generating a sample palm print image provided in the foregoing method embodiments.

An embodiment of this application further provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, so that the computer device performs the method for generating a sample palm print image according to any one of the foregoing method embodiments.

In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this application are merely for description purpose but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

The technical features of the foregoing embodiments may be combined in any combination. To make the description concise, not all the possible combinations of the technical features in the foregoing embodiments are described. However, as long as there is no contradiction between the combinations of these technical features, the combinations are to be considered within the scope of this specification.

The foregoing embodiments only describe several implementations of this application, which are described specifically and in detail, but cannot be construed as a limitation to the patent scope of this application. A person of ordinary skill in the art may make several transformations and improvements without departing from the idea of this application. These transformations and improvements fall within the protection scope of this application. Therefore, the protection scope of the patent of this application shall be subject to the appended claims.

What is claimed is:

1. A sample palm print image generation method, performed by a computer device, comprising:
generating a major palm print line according to a preset major palm print line distribution pattern;
determining a palm print distribution region in which the major palm print line is located;
generating a minor palm print line in the palm print distribution region based on a preset minor palm print line distribution pattern;
generating a candidate palm print image based at least on the major palm print line and the minor palm print line;
labeling the candidate palm print image with a candidate image label that represents a palm print distribution of the candidate palm print image, the palm print distribution including at least one of a major palm print line distribution or a minor palm print line distribution; and
inputting the candidate palm print image to a palm print generation model, to obtain a sample palm print image, the palm print generation model being obtained through pre-training using at least the candidate image label and a palm print image label indicating a palm print distribution of a pre-gathered palm print image.

2. The method according to claim 1, further comprising:
obtaining a palm print image library, the palm print image library pre-storing at least the pre-gathered palm print image;
performing feature extraction on the pre-gathered palm print image, to obtain an image feature representation corresponding to the pre-gathered palm print image;
performing feature extraction on the candidate palm print image, to obtain a candidate feature representation corresponding to the candidate palm print image;
fusing the candidate feature representation and the image feature representation using a candidate generation model and then performing upsampling, to obtain a candidate sample palm print image; and
training the candidate generation model using the candidate sample palm print image, to obtain the palm print generation model.

3. The method according to claim 2, wherein:
the candidate palm print image is one of one or more candidate palm print images each labeled with a corresponding candidate image label; and
training the candidate generation model includes:
determining one candidate palm print image corresponding to the candidate sample palm print image, and determining the candidate image label corresponding to the one candidate palm print image as a sample image label of the candidate sample palm print image;
obtaining, based on a distribution difference between a palm print distribution indicated by the sample image label and the palm print distribution indicated by the palm print image label, a loss value corresponding to the candidate sample palm print image; and
training the candidate generation model using the loss value, to obtain the palm print generation model.

4. The method according to claim 2, wherein fusing the candidate feature representation and the image feature representation and then performing upsampling includes:
performing feature fusion on the candidate feature representation and the image feature representation using the candidate generation model, to obtain a fused feature representation that represents a feature representation obtained after constraint adjustment is performed on the candidate feature representation by using at least the image feature representation; and
upsampling the fused feature representation, to obtain the candidate sample palm print image.

5. The method according to claim 1, further comprising:
obtaining a target feature extraction model, the target feature extraction model being obtained through pre-training using a plurality of palm print images in a palm print image library;
performing feature extraction on the sample palm print image using the target feature extraction model to obtain a first feature representation;
performing feature extraction on the pre-gathered palm print image using the target feature extraction model to obtain a second feature representation; and
performing a label constraint on the sample palm print image based on a feature difference between the first feature representation and the second feature representation, the label constraint being configured to constrain identity consistency between the sample palm print image and the pre-gathered palm print image.

6. The method according to claim 5, wherein performing the label constraint includes:
calculating a cosine similarity between the first feature representation and the second feature representation, to obtain a feature similarity; and
performing the label constraint on the sample palm print image based at least on the feature similarity.

7. The method according to claim 1, further comprising, after inputting the candidate palm print image to the palm print generation model to obtain the sample palm print image:
training a palm print recognition model using the sample palm print image, to obtain a candidate palm print recognition model; and
adjusting the candidate palm print recognition model using at least one palm print image in a palm print image library, to obtain a target palm print recognition model.

8. The method according to claim 1, further comprising:
inputting the candidate palm print image and the pre-gathered palm print image to the palm print generation model, and performing constraint adjustment on the candidate palm print image using the pre-gathered palm print image, to obtain the sample palm print image.

9. The method according to claim 1, wherein generating the major palm print line includes:
generating positioning point data according to the preset major palm print line distribution pattern, the positioning point data including first data corresponding to a first major line positioning point and second data corresponding to a second major line positioning point;
generating adjustment point data according to a major palm print line radian pattern, a major line adjustment point corresponding to the adjustment point data being configured to control a radian of a major line determined by the first major line positioning point and the second major line positioning point; and
generating the major palm print line based on the first data, the second data, and the adjustment point data, the major palm print line being a curve formed by sequentially connecting the first major line positioning point, the major line adjustment point, and the second major line positioning point.

10. The method according to claim 1, wherein generating the minor palm print line includes:
determining a plurality of minor palm print line positioning points in the palm print distribution region based on the preset minor palm print line distribution pattern; and
generating the minor palm print line based on the plurality of minor palm print line positioning points.

11. A computer device comprising:
a processor; and
a memory storing at least one program that, when executed by the processor, causes the processor to:
generate a major palm print line according to a preset major palm print line distribution pattern;
determine a palm print distribution region in which the major palm print line is located;
generate a minor palm print line in the palm print distribution region based on a preset minor palm print line distribution pattern;
generate a candidate palm print image based at least on the major palm print line and the minor palm print line;
label the candidate palm print image with a candidate image label that represents a palm print distribution of the candidate palm print image, the palm print distribution including at least one of a major palm print line distribution or a minor palm print line distribution; and
input the candidate palm print image to a palm print generation model, to obtain a sample palm print image, the palm print generation model being obtained through pre-training using at least the candidate image label and a palm print image label indicating a palm print distribution of a pre-gathered palm print image.

12. The computer device according to claim 11, wherein the at least one program, when executed by the processor, further causes the processor to:
obtain a palm print image library, the palm print image library pre-storing at least the pre-gathered palm print image;
perform feature extraction on the pre-gathered palm print image, to obtain an image feature representation corresponding to the pre-gathered palm print image;
perform feature extraction on the candidate palm print image, to obtain a candidate feature representation corresponding to the candidate palm print image;
fuse the candidate feature representation and the image feature representation using a candidate generation model and then performing upsampling, to obtain a candidate sample palm print image; and
train the candidate generation model using the candidate sample palm print image, to obtain the palm print generation model.

13. The computer device according to claim 12, wherein:
the candidate palm print image is one of one or more candidate palm print images each labeled with a corresponding candidate image label; and
the at least one program, when executed by the processor, further causes the processor to, when training the candidate generation model:
determine one candidate palm print image corresponding to the candidate sample palm print image, and determine the candidate image label corresponding to the one candidate palm print image as a sample image label of the candidate sample palm print image;
obtain, based on a distribution difference between a palm print distribution indicated by the sample image label and the palm print distribution indicated by the palm print image label, a loss value corresponding to the candidate sample palm print image; and
train the candidate generation model using the loss value, to obtain the palm print generation model.

14. The computer device according to claim 12, wherein the at least one program, when executed by the processor, further causes the processor to, when fusing the candidate feature representation and the image feature representation and then performing upsampling:
perform feature fusion on the candidate feature representation and the image feature representation using the candidate generation model, to obtain a fused feature representation that represents a feature representation obtained after constraint adjustment is performed on the candidate feature representation by using at least the image feature representation; and
upsample the fused feature representation, to obtain the candidate sample palm print image.

15. The computer device according to claim 11, wherein the at least one program, when executed by the processor, further causes the processor to:
obtain a target feature extraction model, the target feature extraction model being obtained through pre-training using a plurality of palm print images in a palm print image library;
perform feature extraction on the sample palm print image using the target feature extraction model to obtain a first feature representation;
perform feature extraction on the pre-gathered palm print image using the target feature extraction model to obtain a second feature representation; and
perform a label constraint on the sample palm print image based on a feature difference between the first feature representation and the second feature representation, the label constraint being configured to constrain identity consistency between the sample palm print image and the pre-gathered palm print image.

16. The computer device according to claim 15, wherein the at least one program, when executed by the processor, further causes the processor to, when performing the label constraint includes:
calculate a cosine similarity between the first feature representation and the second feature representation, to obtain a feature similarity; and
perform the label constraint on the sample palm print image based at least on the feature similarity.

17. The computer device according to claim 11, wherein the at least one program, when executed by the processor, further causes the processor to, after inputting the candidate palm print image to the palm print generation model to obtain the sample palm print image:
train a palm print recognition model using the sample palm print image, to obtain a candidate palm print recognition model; and
adjust the candidate palm print recognition model using at least one palm print image in a palm print image library, to obtain a target palm print recognition model.

18. The computer device according to claim 11, wherein the at least one program, when executed by the processor, further causes the processor to:
input the candidate palm print image and the pre-gathered palm print image to the palm print generation model, and perform constraint adjustment on the candidate palm print image using the pre-gathered palm print image, to obtain the sample palm print image.

19. The computer device according to claim 11, wherein the at least one program, when executed by the processor, further causes the processor to, when generating the major palm print line:
generate positioning point data according to the preset major palm print line distribution pattern, the positioning point data including first data corresponding to a first major line positioning point and second data corresponding to a second major line positioning point;
generate adjustment point data according to a major palm print line radian pattern, a major line adjustment point corresponding to the adjustment point data being configured to control a radian of a major line determined by the first major line positioning point and the second major line positioning point; and
generate the major palm print line based on the first data, the second data, and the adjustment point data, the major palm print line being a curve formed by sequentially connecting the first major line positioning point, the major line adjustment point, and the second major line positioning point.

20. A non-transitory computer-readable storage medium storing at least one program stored that, when executed by a processor, causes the processor to:
generate a major palm print line according to a preset major palm print line distribution pattern;
determine a palm print distribution region in which the major palm print line is located;
generate a minor palm print line in the palm print distribution region based on a preset minor palm print line distribution pattern;
generate a candidate palm print image based at least on the major palm print line and the minor palm print line;
label the candidate palm print image with a candidate image label that represents a palm print distribution of the candidate palm print image, the palm print distribution including at least one of a major palm print line distribution or a minor palm print line distribution; and
input the candidate palm print image to a palm print generation model, to obtain a sample palm print image, the palm print generation model being obtained through pre-training using at least the candidate image label and a palm print image label indicating a palm print distribution of a pre-gathered palm print image.
